(19) United States
(12) Patent Application Publication
(10) Pub. No.: US 2025/0277693 A1
(43) Pub. Date: Sep. 4, 2025

(54) INFRASTRUCTURE MONITORING SYSTEMS AND METHODS

(71) Applicant: TERRA15 PTY LTD, Perth, Western Australia (AU)

(72) Inventors: Adrian NOETZLI, Mount Lawley, Western Australia (AU); Alain BARTELS, Duncraig, Western Australia (AU); Oscar James HOWSE, Subiaco, Western Australia (AU); Nader ISSA, Inglewood, Western Australia (AU); George Allin BRAWLEY, Bassendean, Western Australia (AU); Stephen John FEWINGS, Floreat, Western Australia (AU); Michael Alberic Freddy ROELENS, Glendalough, Western Australia (AU)

(73) Assignee: TERRA15 PTY LTD, Perth, Western Australia (AU)

(21) Appl. No.: 18/857,291

(22) PCT Filed: Apr. 18, 2023
(86) PCT No.: PCT/AU2023/050314

§ 371 Date: Oct. 16, 2024

(30) Foreign Application Priority Data
Apr. 19, 2022 (AU) 2022901038

(51) Int. Cl. G01H 9/00

(52) U.S. Cl. CPC G01H 9/006

(57) ABSTRACT

A method for monitoring an infrastructure of interest, the method comprising: providing a distributed acoustic sensor, an analysis module, and optical fibre cable adjacent to the infrastructure wherein the optical fibre cable is divided into one or more sections, and the distributed acoustic sensor generates DAS sensor data from the one or more sections; providing a processing module comprising one or more processors and a memory, wherein the memory comprises at least two or more processing algorithms, wherein the one or more processors are configured to execute the processing algorithms with the DAS sensor data as input, wherein each processing algorithm is configured to provide an output state for each section of the optical fibre cable adjacent to the infrastructure of interest.

### FIELD OF THE INVENTION

The present invention relates to infrastructure monitoring systems utilising distributed acoustic sensing and methods for operating infrastructure monitoring systems.

The invention has been developed primarily for use in methods and systems for infrastructure monitoring utilising distributed acoustic sensing and will be described hereinafter with reference to this application. However, it will be appreciated that the invention is not limited to this particular field of use.

### BACKGROUND

Any discussion of the background art throughout the specification should in no way be considered as an admission that such background art is prior art, nor that such background art is widely known or forms part of the common general knowledge in the field in Australia or worldwide as at the priority date of the present application.

All references, including any patents or patent applications, cited in this specification are hereby incorporated by reference, which means that it should be read and considered by the reader as part of this text. That the document, reference, patent application or patent cited in this text is not repeated in this text is merely for reasons of conciseness.

No admission is made that any reference or documentation cited in the present specification constitutes prior art. The discussion of the references states what their authors assert, and the applicants reserve the right to challenge the accuracy and pertinence of the cited documents. It will be clearly understood that, although a number of prior art publications may be referred to herein, such reference does not constitute an admission that any of these documents forms part of the common general knowledge in the art, in Australia or in any other country, at the priority date of the application.

Distributed Acoustic Sensing (DAS) is a technology that enables simultaneous, continuous, real-time measurements at many points along the entire length of an optically transparent sensing medium and may be extended to simultaneous measurements at every point along an optical path in the sensing medium. Unlike traditional sensors that rely on discrete sensors measuring at pre-determined points, many embodiments of a distributed sensing system utilise a sensing medium comprising optical fibre where the fibre is the sensor. These systems allow acoustic signals to be detected at many locations over large distances and in harsh environments. DAS, also known as distributed vibration sensing, works by sending short pulses of optical light into a fibre optic cable and measuring Rayleigh backscattering that occurs due to small variations in the refractive index, that are intentionally or unintentionally introduced during the fibre manufacturing process, to measure small changes in the physical properties of the fibre along the entire length of the fibre in a distributed manner. When a sound and/or vibration perturbs the fibre optic cable, the cable stretches or contracts which causes a slight change in the flight time of the reflected light in the fibre. Such small variations in the reflected optical signal are measured by specialised DAS equipment, also known as a DAS interrogator. The acoustic data which caused the fibre perturbation is accurately encoded in the reflected time-of-flight data detected by the DAS interrogator which is able to reconstruct the original perturbation signal. The fibre sensor detects acoustic information from anything that generates a sound or vibration such as flowing water, rainfall, vehicles, pedestrians, ships, submarines, wind, motors, machinery, bearings, gas leaks, fluid leaks, pressure transients in pipes, tools, electrical arcs, turbines, generators, earthquakes, ground deformation, digging, construction, tampering, ocean swell, explosions, music and passive and ambient seismic sources.

In general, using optical fibre (with or without the protection of a cable jacket) as a distributed sensor can replace many discrete point sensors. As a result, it can be the most cost-effective, and weight-and space-efficient sensor system available for sensing over long distances as it only requires one fibre. That fibre is capable of sending, receiving, and sensing the signal from the same fibre and only one monitor is adequate to display the local changes in temperature, stress, vibration and acoustic energy along the entire length of the sensing fibre simultaneously and continuously. In addition, optical fibres are well adapted to operating in harsh environments and are immune from damage or noise-induced by electromagnetic interference. This considerable light-weight advantage makes distributed sensors based on distributed light scattering in optical fibre amongst the most versatile monitoring options even in comparison to point fibre sensors, especially for monitoring of long linear assets, such as pipelines, wells, railways, roads, conveyors, bridges, tunnels, buildings, and fences.

Known DAS systems work by coupling laser energy pulses into optical fibre and analysing Rayleigh backscatter that results from microscopic imperfections and inhomogeneities in the optical fibre. Light pulses, as they travel from the input along the fibre to the far (distal) end, reflect off these microscopic imperfections/inhomogeneities. Such interactions cause a small amount of light to backscatter which is coupled back along the fibre to the input end where the DAS interrogator is located where they are detected and analysed. The source laser which generated the input light signals is often included within the DAS interrogator. Acoustic waves in the vicinity of the sensing fibre, when interacting with the materials that comprise the optical fibre, create elongations in the microscopic structure of the fibre, as well as small changes in the fibre refractive index. These changes affect the backscatter characteristics, becoming measurable phenomena. Using time-domain techniques or frequency domain techniques, the original location of the backscatter signal is precisely determined, providing fully distributed sensing along the entire length of the optical sensing fibre with a resolution of 10 meters or less.

DAS differs from conventional distributed strain sensing in that it does not use the nonlinear Brillouin backscattering to achieve a measurement. This enables very sensitive, linear, and fast distributed measurements. For example, sub-nanostrain sensitivity, at measurement rates higher than 2 kHz and spatial resolutions shorter than 10 m can be achieved with DAS systems.

Identification of phenomena affecting a DAS optical fibre, and by inference identifying phenomena that will or would be likely to affect any nearby infrastructure such as buildings, pipelines, roads, etc, has traditionally been performed using a range of methods for analysing the detected optical return signals comprising the distributed acoustic sensing data, including:
Correlating the distributed acoustic sensing data with a known spectral and/or temporal sample of the event that is being detected, for example, construction sounds. If the correlation is high, an alert is raised that the activity has been first detected. The primary issue with this approach is that the first detected activity may have a completely different spectral signature to the signature under investigation, or a completely different activity might be detected, leading to potential false negative and/or false-positive identifications of the detected activity.
Comparing sound amplitudes of the distributed acoustic data against a known historical sound level. If a predetermined sound amplitude threshold is exceeded, an alert is raised. The primary issue with this approach is that distributed acoustic sensing data contains short-term transient, diurnal and spatial trends, so the threshold needs to be set at a higher level than these variations. The effect of this is reduced sensitivity.
Comparing the spectrum of the distributed acoustic sensing data with a known spectral baseline. The comparison can be made by statistical analysis of the two spectra, such as computing the number of spectral peaks, computing the fundamental frequency, computing the spectral energy, computing the spectral spread, and other statistical analysis. If the two spectra are vastly different, or the characteristics of the spectrum suddenly change, this could be indicative of an alert-generating event or activity on or in the vicinity of the sensing fibre. The primary issue with this approach is that it doesn't work well in noisy environments, such as on mine sites, industrial sites or in urban areas, and is susceptible to false positives from environmental sounds such as rivers, rain, wind, construction, vehicle motion, and machinery.
Comparing the sound levels in the distributed acoustic sensing data against historical sound levels at the same time each day or on a particular day of the week. If the current sound level exceeds the normal statistical bounds of the historical sound levels, this can be flagged as an alert-generating event. In an urban environment, this is particularly problematic due to unpredictable activity that can occur at any time of day or night, including sounds due to construction, digging, boring, road works, and sudden changes in the urban environment, such as nightclubs that may have varying operating times. Sound sources due to weather can also impact this approach.
Calculate the temporal sound gradient of the distributed acoustic sensing data. If the temporal sound gradient exceeds a predetermined threshold, this may indicate increased sound due to an alert-generating event or activity. The primary issue with this approach is that it is susceptible to errors, particularly in an urban environment. The gradient threshold may need to be set so high that events or activities that don't generate a suddenly high increase in sound can be missed, for example, a pipe with a small leak. This approach is also affected by diurnal trends that could mask a small persistent sound.

Existing DAS systems have been utilised for monitoring undesirable phenomena related to, or in the vicinity of, various types of infrastructure systems including, for example:
Monitoring of pipeline for leaks or unauthorised digging or drilling in the vicinity of a pipeline which could indicate a potential damage event or a sabotage event [see Distributed Optical Fibre Sensors and Their Applications in Pipeline Monitoring, P. Rajeev, J. Kodikara, W. K. Chiu, T. Kuen, Key Engineering Materials Vol. 558 (2013) pp 424-434];
Monitoring of freeways or motorways for detection of incidents or events which would adversely impact traffic flows;
Monitoring of rail infrastructure to detect events such as damage to the rail, the presence and location of maintenance work on or in the vicinity of the rail; or attempts to sabotage the rail network [see Acoustic sensing—The future for rail monitoring? by Clive Kessell, The Rail Engineer, p 32-34, April 2014]; or
Detection of seismic activity or events including earthquakes in the vicinity of critical infrastructure such as power stations to allow precautionary measures to be taken to minimise any potential damage or to trigger an assessment of the infrastructure integrity once a detected event has passed [see UK Patent Application No. GB2476449A 2009 to QinetiQ Limited].

To date, however, DAS monitoring systems are used solely to monitor for the occurrence of events (an event being defined as a sudden acoustic change) that may be indicative of an adverse outcome for the monitored infrastructure or installation and the generation of alerts or alarms on detection of an event likely to cause an adverse outcome for the monitored infrastructure. For example, current DAS monitoring systems are directed to the detection of events that are accurately detected and located in real-time. This information is then presented in a decision-ready format as an alert or alarm to an infrastructure management team to allow the appropriate response, for example, the dispatch of a response team to investigate onsite or to alert relevant authorities of a potential adverse event affecting the monitored infrastructure. In this manner, DAS monitoring systems have been designed to alert only at the detection of a sudden event or acoustic change, or at the onset of a condition (also sometimes described as an Infrastructure State or simply State).

Analysis of optical distributed acoustic signals from a DAS system is a complex procedure and identification of an adverse event requires signal processing methods to reduce signal noise and identify particular acoustic signatures in the detected optical signals which are associated with a predetermined event classification, and usually involves a detected signal which exceeds a predetermined threshold to thus trigger an event alert or alarm. However, simply triggering an event alert based on a threshold exceedance has many significant problems for the interpretation of such event alerts by the infrastructure management team.

In the first instance, the DAS system can often generate many false-positive-alerts or nuisance alarms simply on detection of an acoustic signal that either exceeds the predetermined threshold or resembles a predetermined acoustic signature. However, not all such signatures relate to an ongoing condition that requires a response. Also, if the onset of a condition that triggers the initial alert is ongoing, the alert reporting system is prone to generating many alerts all relating to the same condition. This multiple-alert response of the monitoring system has the potential to cause significant confusion for the infrastructure management team as it is quite difficult and time-consuming to correlate each of potentially many alert warnings to a single condition or phenomenon and to determine which of the generated alerts actually require a response. This can be particularly difficult if the situation along the optical DAS sensing fibre experiences an initial change that triggers an alert response, but soon after returns to a natural baseline state. This could indicate that, while a potentially adverse event happened in the vicinity of the sensing fibre, once the condition has passed and the system returns to normal, the potentially adverse outcome may be alleviated. This type of situation may arise in pipeline monitoring if heavy machinery is driven over or near to the sensing fibre which could trigger an increased backscatter acoustic signal exceeding an event threshold or resembling a vibration signal which may indicate digging and a potential sabotage event near the pipeline. When the heavy vehicle moves away from the sensing fibre, the event which triggered the alert has passed with no further potential for damage to the pipeline. However, the initially triggered alert remains in the infrastructure monitoring system and must be reviewed and actioned by the infrastructure management team, even though there is no ongoing risk to the monitored pipeline. This situation arises since, once the DAS system triggers an alert to the infrastructure management team, the DAS system has no further control over that alert and thus there is no option for the DAS system to retract or to update a previously generated event alert. Therefore, the DAS alert-type system has the potential for significant confusion to be generated in the infrastructure management team which requires significant resources to determine which of the alerts generated by the system are real event alerts or are indicative of an ongoing infrastructure fault.

Furthermore, the response time of an infrastructure management team will typically be measured in time frames of many hours (e.g., to activate a camera in the vicinity of the detected event and review visual camera footage to confirm a potentially adverse event) or even days (to dispatch a response team to the event location), therefore the real-time alerting of each detected event can cause the infrastructure management team to be quickly overwhelmed, particularly due to the likelihood of many false positive/active alerts.

A further problematic consideration of an event-alert-generating monitoring system is that it can only provide an alert to the initial onset of the conditions in the backscatter signals that are associated with a potential adverse event which would warrant an alert signal to be sent to the infrastructure management team. Often insufficient information is available at the time of the alert-generating acoustic event to provide adequate certainty in identifying the event since the ongoing characteristics of the acoustic information are required to make a confident assessment of the type of condition and associated risk. Often, additional sensor information or system information is required to be considered together with the DAS information to make a confident assessment of the type of condition and associated risk, but the additional information may not be available at the onset time. As noted above, the initially generated alert cannot be updated or modified to indicate either an ongoing activity, such as, for example, a pipeline leak, or a transient event that on passing poses no further risk to the integrity of the monitored infrastructure installation which would require intervention or further investigation from the infrastructure management team.

A further problematic consideration of an event-alert-generating monitoring system is that alerts or alarms are generated and often transmitted at unpredictable and undefined times. In this manner, the absence of an alert or alarm implies the absence of an event. This implied relation can be misleading to the infrastructure management team, since there are various scenarios in which the occurrence of an event does not generate an alert or alarm, including: loss of communication to the DAS sensor system; failure of a component within the monitoring system; damage to the optical fibre cable used for DAS; and/or inappropriate settings used for event detection or thresholding.

The minimisation of nuisance alarms in a continuous real-time monitoring system is critically important to the effective use of such a monitoring system. Accordingly, there is a real and significant unmet need for improved infrastructure monitoring systems and methods for efficient infrastructure monitoring.

### SUMMARY

It is an object of the present invention to overcome or ameliorate at least one or more of the disadvantages of the prior art, or to provide a useful alternative.

The present invention relates to systems and methods for monitoring the state of a monitored infrastructure or installation utilising the measurement of quantitative and distributed measurements of optical path length changes in an optically transparent medium such as, for example, along an optical fibre as a DAS system in conjunction with a plurality of complementary sensors to continuously report a health state of the infrastructure (including the DAS system itself). Multiple physical parameters may be sensed by the DAS by the consequential optical path length changes created by changes in those physical parameters, which may include; longitudinal strain, transverse strain, acoustic waves, seismic waves, vibration, motion, bending, torsion, temperature, optical delay and chemical composition. Any other physical parameter having a mechanism that induces elongation and/or refractive index change and/or deformation along an optical path can also be sensed. Optical path length changes can also occur by the movement of scattering/reflecting particles in the sensing medium. Embodiments of the invention disclosed herein use an intensity-modulated (or pulsed) broadband light source in conjunction with delays and accurate phase and amplitude measurement on the distributed backscatter from an optically transparent sensing medium, for example, an optical fibre.

According to a first aspect of the invention, there is provided a method for monitoring an infrastructure of interest. The method may comprise providing a distributed acoustic sensor, an analysis module, and optical fibre cable adjacent to the infrastructure. The optical fibre cable may be divided into one or more sections. The distributed acoustic sensor may generate DAS sensor data from the one or more sections.

The method may further comprise providing a processing module. The processing module may comprise one or more processors and a memory. The memory may comprise at least two or more processing algorithms. The one or more processors may be configured to execute the processing algorithms with the DAS sensor data as input.

Each processing algorithm may be configured to provide an output state for each section of the optical fibre cable adjacent to the infrastructure of interest.

According to a particular arrangement of the first aspect, there is provided a method for monitoring an infrastructure of interest, the method comprising:
providing a distributed acoustic sensor, an analysis module, and optical fibre cable adjacent to the infrastructure wherein the optical fibre cable is divided into one or more sections, and the distributed acoustic sensor generates DAS sensor data from the one or more sections; and
providing a processing module comprising one or more processors and a memory, wherein the memory comprises at least two or more processing algorithms, wherein the one or more processors are configured to execute the processing algorithms with the DAS sensor data as input;
wherein each processing algorithm is configured to provide an output state for each section of the optical fibre cable adjacent to the infrastructure of interest.

The one or more sections of the optical fibre cable may be virtual sections. The method may further comprise the step of using the output states of at least two processing algorithms and a decision module to generate one or more infrastructure states in respect of each section of optical fibre cable adjacent to the infrastructure of interest.

The method may further comprise the step of transmitting the one or more infrastructure states to an infrastructure state receiving system (ISRS) at approximately predetermined time intervals.

A processing algorithm may be a fibre signal quality algorithm and/or a fibre damage algorithm.

The infrastructure of interest may be a pipeline. The infrastructure of interest may be a cable. The infrastructure of interest may be a conveyor. The infrastructure of interest may be an embankment or tailings storage facility. The infrastructure of interest may be an underground tunnel or mine tunnel/shaft. The infrastructure of interest may be an open-pit mine. The infrastructure of interest may be a well or borehole.

A processing algorithm may receive as an input a prior infrastructure state from the same or different sections of the optical fibre cable adjacent to the infrastructure of interest.

Additional sensors may be used and the analysis module may receive additional sensor data from the additional sensors as input to the one or more processing algorithms, including cameras, traffic summaries, vehicle location, public event data feeds, water flow counters, weather data feeds, geo-location of known landmarks such as hydrants, road intersections, utility pits and terrain variations, distributed temperature sensing, distributed fibre optic sensing, accelerometers, seismometers, geophones and hydrophones.

A processing algorithm may be selected from one or more of the group comprising: a skewness algorithm, an envelope demodulation algorithm, a neural network algorithm, a machine learning classifier algorithm, a spatial correlation algorithm, a temporal correlation algorithm, a machinery identification algorithm, a rainfall algorithm, a temperature anomaly algorithm, a flow rate anomaly algorithm, a pressure anomaly algorithm, a communication status algorithm, a spectral filtered power algorithm, a diurnal filtering algorithm, a fibre signal quality algorithm, a fibre damage algorithm, a Bayesian classifier algorithm, an STLT algorithm, a root mean squared (RMS) algorithm, a shape factor algorithm, a crest factor algorithm, or a cross-correlation algorithm.

The decision module may use any one or more of: simultaneity check; persistence check; transience check; DAS data quality check; DAS data availability check; map check; video check; fibre cable check; bayesian decision check, and/or an infrastructure state check.

The infrastructure state and/or ISRS may be used to determine an inspection and/or maintenance response of the infrastructure.

According to a second aspect of the invention, there is provided a system for monitoring infrastructure comprising:
a distributed acoustic sensing (DAS) system, comprising:
   an optical fibre located in the vicinity of the infrastructure;
   an optical source for generating source optical signals;
   a modulator for modulating the source optical signals;
   launch means for launching the modulated optical signals into the optical fibre;
   a detector for receiving backscattered optical signals from the optical fibre;
   a detector for detecting the received backscatter signals; and
   an analysis processor for receiving the detected backscatter signals and determining an infrastructure state; and
an output module reporting the infrastructure state at predetermined time intervals.

The infrastructure may be selected from the group comprising a pipeline, a cable, a conveyor, or an embankment or tailings storage facility.

A processing algorithm may be an optical power or optical signal to noise measurement with threshold comparison indicative of fibre continuity or usable state.

A processing algorithm may also receive information from one or a plurality of alternative sensors. A processing algorithm may receive one or more infrastructure states from previous iterations of the selection process.

A processing algorithm may be selected from one or more of the group comprising: a vibration energy in a defined frequency range with threshold comparison indicative of the presence of vibration signals above or below a selected threshold; a short-term-average long-term-average ratio using percentile ranked vibration energy in a defined frequency range and with threshold comparison applied to this ratio; a cross-correlation method with threshold comparison; a kurtosis estimation with threshold comparison; a short-term-average long-term-average ratio using kurtosis estimation with threshold comparison applied to this ratio; an envelope analysis with threshold comparison; a neural network with discrete state output; and/or a classifier algorithm with discrete state output; indicative of the presence or magnitude or change thereof of vibration signals.

The detector may be a phase and amplitude detector with full quadrature determination without ambiguity in a range of 2π radians.

The selection process may use a persistency check on at least one output state. The selection process may use a simultaneity check on multiple output states. The infrastructure state and analysis processor may be used to determine an inspection and/or maintenance response. The analysis processor may use complementary information such as cameras, traffic summaries, vehicle location, public event data feeds, water flow counters, weather data feeds, geo-location of known landmarks such as hydrants, road intersections, utility pits and terrain variations. A processing algorithm may include as an input, a prior infrastructure state from the same and/or different section and/or infrastructure monitoring system. The one or plurality of processing algorithms may be located on a computer connected to the optical fibre and/or on a cloud-based computer.

According to a third aspect of the invention, there is provided a method for monitoring infrastructure comprising:
providing a distributed acoustic sensing (DAS) system, comprising:
   an optical fibre located in the vicinity of the infrastructure;
   an optical source for generating source optical signals;
   a modulator for modulating the source optical signals;
   launch means for launching the modulated optical signals into the optical fibre;
   a detector for receiving backscattered optical signals from the optical fibre;
   a detector for detecting the received backscatter signals;
   an analysis processor for receiving the detected backscatter signals and determining an infrastructure state; and
   an output module reporting the infrastructure state at predetermined time intervals;
detecting distributed backscatter signals from the DAS system to provide DAS sensor data;
providing one or a plurality of additional sensors and receiving additional sensor data;
processing the DAS sensor data and the additional sensor data using one or a plurality of processing algorithms to generate a corresponding one or plurality of output states;
comparing the one or plurality of output states with one or more predetermined conditions to provide an infrastructure state; and
reporting the infrastructure state at predetermined time intervals.

The one or plurality of processing algorithms may be selected from one or more of the group comprising: a vibration energy in a defined frequency range with threshold comparison indicative of the presence of vibration signals above or below a selected threshold; a short-term-average-long-term-average ratio using percentile ranked vibration energy in a defined frequency range and with threshold comparison applied to this ratio; a cross-correlation method with threshold comparison; a kurtosis estimation with threshold comparison; a short-term-average long-term-average ratio using kurtosis estimation with threshold comparison applied to this ratio; an envelope analysis with threshold comparison; a neural network with discrete state output; and/or a classifier algorithm with discrete state output, to provide an output indicative of the presence or magnitude or change of thereof of vibration signals.

One embodiment provides a non-transitive carrier medium for carrying computer executable code that, when executed on a processor, causes the processor to perform a method as described herein.

One embodiment provides a system configured for performing a method as described herein.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 shows a schematic depiction of a distributed acoustic sensing (DAS) infrastructure monitoring system;

FIG. 2 illustrates a method of infrastructure monitoring utilising the DAS infrastructure monitoring system of FIG. 1;

FIG. 3 shows a computing device on which the various embodiments described herein may be implemented in accordance with an embodiment of the present invention;

FIG. 4 illustrates a distributed acoustic sensing (DAS) infrastructure monitoring system where the analysis module can exist on the edge acquisition computer and on the cloud server computers;

FIG. 5 illustrates the display of Infrastructure states on a map;

FIG. 6 illustrates a method of displaying infrastructure states over time for all locations along a fibre;

FIG. 7 illustrates a method in infrastructure monitoring for the example of pipeline leak monitoring; and

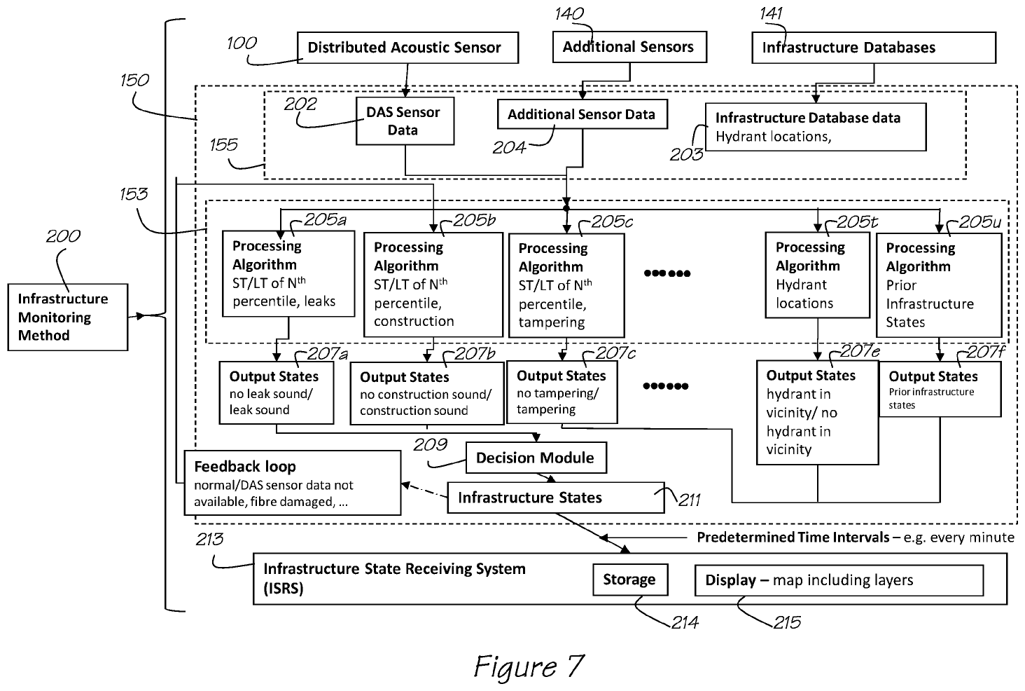

FIG. 8 illustrates a method in infrastructure monitoring for the example of conveyor bearing, roller and pulley fault monitoring.

In the drawings, like structures are referred to by like numerals throughout the several views. The drawings shown are not necessarily to scale, with emphasis instead generally being placed upon illustrating the principles of the present invention.

### DEFINITIONS

The following definitions are provided as general definitions and should in no way limit the scope of the present invention to those terms alone, but are put forth for a better understanding of the following description.

Unless defined otherwise, all technical and scientific terms used herein have the same meaning as commonly understood by those of ordinary skill in the art to which the invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The articles “a” and “an” are used herein to refer to one or to more than one (i.e., to at least one) of the grammatical object of the article. By way of example, “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

As used herein in the specification and in the claims, the phrase “phase and amplitude receiver” is used to describe a receiver system (or “phase and amplitude measurement” is used to describe a receiving method) that is capable of accurately measuring and outputting the following 2 parameters:
the difference in phase (with full quadrature determination, i.e., without ambiguity in a range of 2π radians) between 2 electromagnetic wave (e.g., optical) inputs; and
the amplitude of the interference between 2 electromagnetic wave (e.g., optical) inputs.

As used herein in the specification and in the claims, the phrase “optical frequencies” is used to describe optical electromagnetic radiation with frequency in the range from about 1×10¹³ Hz to 3×10¹⁵ Hz. An “optical source” or laser is a source of electromagnetic radiation at optical frequencies.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others. Thus, “including” is synonymous with and means “comprising”.

In the claims, as well as in the summary above and the description below, all transitional phrases such as “comprising”, “including”, “carrying”, “having”, “containing”, “involving”, “holding”, “composed of”, and the like are to be understood to be open-ended, i.e., to mean “including but not limited to”. Only the transitional phrases “consisting of” and “consisting essentially of” alone shall be closed or semi-closed transitional phrases, respectively.

The term, “real-time”, for example, “displaying real-time data”, refers to the display of the data without intentional delay, given the processing limitations of the system and the time required to accurately measure the data. Similarly, a process occurring “in real-time” refers to operation of the process without intentional delay or in which some kind of operation occurs simultaneously (or nearly simultaneously) with when it is happening.

The term, “near-real-time”, for example, “obtaining real-time or near-real-time data” refers to the obtaining of data either without intentional delay (“real-time”) or as close to real-time as practically possible (i.e., with a small, but minimal, amount of delay whether intentional or not within the constraints and processing limitations of the system for obtaining and recording or transmitting the data.

Although any methods and materials similar or equivalent to those described herein can be used in the practice or testing of the present invention, preferred methods and materials are described. It will be appreciated that the methods, apparatus, and systems described herein may be implemented in a variety of ways and for a variety of purposes. The description here is by way of example only.

The various methods or processes outlined herein may be coded as software that is executable on one or more processors that employ any one of a variety of operating systems or platforms. Additionally, such software may be written using any of several suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst several different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey a relationship between the fields. However, any suitable mechanism may be used to establish a relationship between information in fields of a data structure, including through the use of pointers, tags or other mechanisms that establish a relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either”, “one of”, “only one of”, or “exactly one of.” “Consisting essentially of”, when used in the claims, shall have its ordinary meaning as used in the field of patent law.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B”, or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

For the purpose of this specification, where method steps are described in sequence, the sequence does not necessarily mean that the steps are to be carried out in chronological order in that sequence, unless there is no other logical manner of interpreting the sequence.

In addition, where features or aspects of the invention are described in terms of Markush groups, those skilled in the art will recognise that the invention is also thereby described in terms of any individual member or subgroup of members of the Markush group.

### DETAILED DESCRIPTION

Disclosed herein are systems and methods for continuous real-time and spatially-resolved monitoring of infrastructure using an optical fibre DAS system which is capable of simultaneously monitoring many points (up to and including at every point) of an optical path along the length of the sensing fibre.

The infrastructure capable of being monitored by the systems and methods disclosed herein include, for example, utilities, assets or installations that can reasonably allow an optic fibre installed within proximity of the infrastructure. Infrastructure suitable for optical fibre may be long linear assets, however, is not exclusive to linear assets. Utility infrastructure includes, for example, pipelines such as freshwater, wastewater, natural gas, hydrogen, ammonia, slurry, tailings, concentrate, chemicals, oil, gasses, liquids, and which may be located either subsea, underground, or aboveground cables. A non-exhaustive list of example infrastructure utilities of cables or conduits suitable for monitoring by the systems and methods disclosed herein include power (both high voltage and low voltage), telecommunications, instrumentation, subsea, underground, and aboveground. Additionally, infrastructure suitable for monitoring by the presently disclosed systems includes transport infrastructure including, for example, rail, road, and aircraft runways. Monitoring may include monitoring the state of the transport infrastructure as well as its utilisation. Utilisation includes, for example: the number, size, direction, and velocity of vehicles on a road; the presence of trains on rails and the train length, velocity, direction and impact on the rail infrastructure. Additionally, infrastructure suitable for monitoring by the presently disclosed systems includes mining infrastructure including fixed plant, mobile plant, conveyors, pipelines, diggers, reclaimers, cables, open pit mines, underground tunnels, slopes, embankments, dam walls, tailings storage facilities. The monitoring may be configured to monitor the integrity of the asset as well as utilisation of the asset, e.g., for a dam wall, it may include the pressure on and/or internal strain within the dam. For utility monitoring, the system may be configured to monitor the passage of vehicles, foot and/or water over-flow rates. Additionally, infrastructure suitable for monitoring by the presently disclosed systems includes energy infrastructure including oil and gas wells, carbon geo-sequestration sites and wells, geothermal wells, wind turbines, cables to solar and wind farms, vehicles such as trucks, trains, planes, ships and submarines. Many other types of business-critical infrastructure would also be suitable for monitoring by the systems and methods disclosed herein as would be appreciated by the skilled addressee.

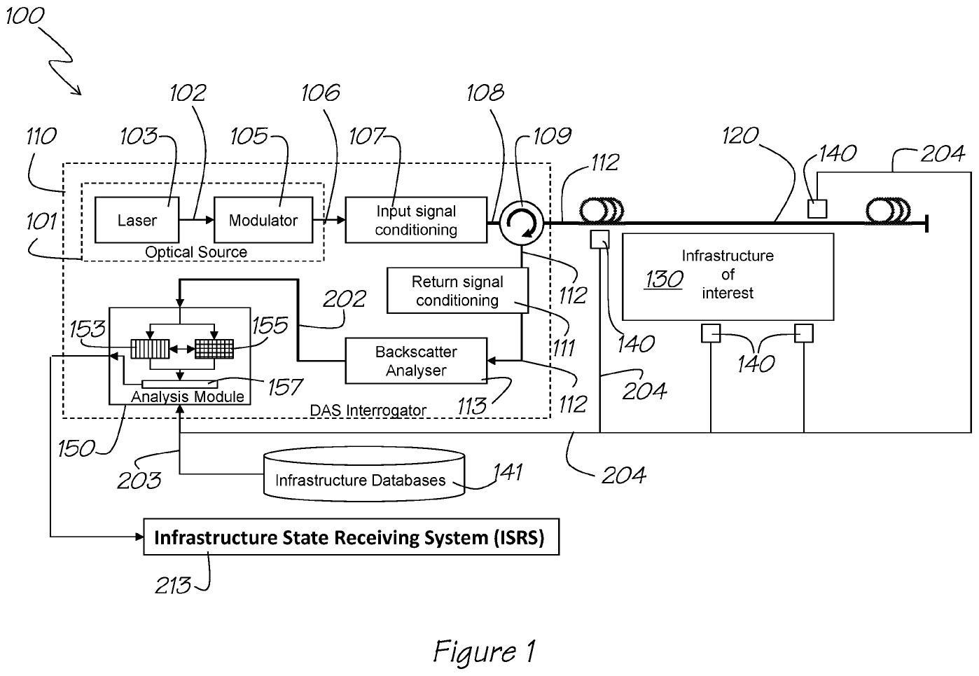

An example arrangement of a DAS monitoring system 100 is shown schematically in FIG. 1. DAS system 100 broadly comprises a DAS Interrogator 110 and a connected optical fibre 120 acting as the distributed sensing medium.

Distributed acoustic sensing data is acquired from optical fibre 120 that runs adjacent to the infrastructure 130 that is to be monitored, where, in some embodiments, at least a portion of the optical fibre 120 may optionally be in direct physical contact with the infrastructure. The optical fibre 120 may be repurposed telecommunications fibre already installed as part of an existing fibre cable network, but where the fibre, or a fibre channel (a portion of the bandwidth of the fibre defined as a function of the wavelength or frequency of light propagating in the fibre), within a fibre cable or fibre bundle, is not currently used for telecommunications. Other fibres and/or fibre channels within the fibre cable network may be simultaneously used for telecommunications and/or data communication purposes without adverse disruption or interference to the DAS signals.

The optical fibre 120 is installed, or existing optical fibre cables selected, such that it passes close to or included with the monitored infrastructure 130. The fibre 120 may already be installed as part of a telecommunication optical fibre cable or bundle. It may be installed purposefully for infrastructure monitoring or may comprise an existing optical fibre installation in the vicinity of the infrastructure 130. Existing optical fibre cable comprises a plurality of optic fibres, each independent of other fibres in the cable bundle. An optic fibre cable will also typically include one or more unused optic fibres, which may be utilised to provide headroom for increased data traffic for redundancy or future expansion, but which are generally unused or normally unlit by an optical signal. Such fibres are usually known as ‘dark’ fibres. Optical fibre 120 of DAS system 100 can take advantage of the existing installed optical fibre cable by repurposing a dark fibre in the cable for use as DAS sensing medium 120. Alternatively, if there are no dark fibres in an existing optical fibre cable installation, the existing fibre cable bundle can still be used as sensing medium 120. For example, DAS optical signals from interrogator 110, may be shared with telecommunications (or other) data being transmitted over an optic fibre 120 in the bundle. This may be achieved either: by time-division-multiplexing of the DAS optical signals with the communications signals where the signals from each source are transmitted along the fibre 120 at different times; and/or by wavelength division multiplexing (WDM) of optical signals in the optical fibre, whereby optical signals of different wavelength or frequency are able to be transmitted by the fibre in a frequency ‘channel’ without interference between other channels. WDM permits multiple data streams to be transmitted through the fibre simultaneously, with each data stream in each channel being transmitted with a different optical wavelength. In an existing fibre optic network, data signals are usually restricted to a narrow frequency band or channel. In an existing network that does not utilise a particular channel, that unused channel is generally known as a ‘dark’ channel. Thus, DAS sensing medium optic fibre 120 may be a dedicated optical fibre link, or alternatively, a dark fibre and/or dark channel of an existing optical fibre cable installation. Alternatively, a fibre may be installed at the time the infrastructure is installed or installed after installation. A combination of pre-installed and later installed fibre may be used for sensing medium 120 of DAS system 100.

An optical fibre 120 may be installed adjacent to machinery and/or any other rotating or moving equipment, for example: motors, fans, and compressors; or electrical, hydraulic, and pressured air or steam bearing motors, fans, and compressors. DAS system 100 is ideally suited to applications where there are many rotating bearings such as large mechanical factories, processing plants, conveyors, escalators, travelators, cable cars, ski lifts and low-loader trucks.

DAS Interrogator 110 comprises a source 101 of optical radiation which is launched onto a sensing medium, typically an optical fibre 120 which is located within or near an infrastructure 130 to be monitored. DAS system 100 further comprises a directing means 109, such as, for example, an optical circulator that receives a modulated optical signal 106 (or optionally, modulated and further conditioned optical signal 108) and launches it onto the sensing medium 120. Backward propagating backscattered light 112 from sensing medium 120 is received by circulator 109 and directed to a backscatter analyser 113 comprised with DAS interrogator 110. Backscatter analyser 113 measures the returned Rayleigh backscatter to measure variations of distance to each section of the fibre and so determine vibrations, deformation, deformation rate, velocity, strain and/or strain-rate variations in time on fibre sensing medium 120.

An optical signal 102 is generated by an optical source 101, often comprising a laser 103. Optical signal 102 from optical source 101 is optionally modulated by modulator 105 to generate an intensity-modulated optical signal 106. In alternative arrangements, optical source 101 is a pulsed laser source generating an intensity-modulated optical signal 106. In still further arrangements optical source 101 may have modulator 105 incorporated therewith. The optical signal 102 is preferably modulated within the optical source 101 or alternatively, anywhere before entering the sensing medium (such as a sensing optical fibre) 120. Modulator 103 may be adapted to modulate any one or more of the intensity, frequency, phase or polarisation of the light 102 prior to sensing medium 160. Pulses or coded modulation are examples of possible modulation schemes which can be used. Possible alternative means for modulation as would be appreciated by the skilled addressee may include, for example: electro-optic modulators; acousto-optic modulators; optical switches; direct source modulation; and saturable absorbers. Possible modulation schemes may include: pulsing; pseudo-random coding; simplex Code; Golay Code; linear frequency chirp; Barker Code, or the like. In particular arrangements, the optical signal 106 is an amplitude modulated signal where the amplitude modulation may be induced by modulating one or more of the above-referenced parameters of the optical signal, not just by simply modulating the amplitude (e.g., intensity or optical power) directly.

In particular arrangements, backscatter analyser 113 comprises a phase and amplitude detector capable of accurately measuring both the intensity and phase without ambiguity in a range of 2π radians of the received backscatter optical signals 112. In particular arrangements of system 100 depicted in FIG. 1, optical source 101, directing means 109 and backscatter analyser 113 are all included in a DAS interrogator system 110, however, in particular arrangements, the optical source 101, backscatter analyser 113 directing means 109 and other components may be provided separately. DAS interrogator 110 may also include an additional optical input signal conditioning module 107, which may apply additional signal conditioning to the modulated optical signal 106 prior to being launched onto sensing medium 120. DAS interrogator 110 may also include an additional optional optical return signal conditioning module 111, which may apply additional signal conditioning to the backscattered light 112 from sensing medium 120. Such additional input and return signal conditioning may optionally include, for example, optical delays, optical combiners, frequency shifters, phase modulators, amplifiers, optical filters and interferometers.

A particular example of a DAS system which is suited to infrastructure monitoring is provided by U.S. Pat. No. 11,237,025 to Issa et al. The DAS system disclosed in Issa et al is particularly effective in noisy environments, for example, within an urban environment setting with many sound sources, for example, vehicular and/or pedestrian traffic, and/or construction work or the like. However, DAS systems of different configurations are also well suited to DAS infrastructure monitoring system 100 as would be appreciated by the skilled addressee.

Detected optical signals are passed from backscatter analyser 113 to an analysis processor module 150.

System 100 further comprises a plurality of additional sensors 140 which are located so as to receive additional sensor data 204 in relation to the state of the infrastructure 130 or the optical fibre sensing medium 120 or collection of any other sensor data relevant to the state of infrastructure 130. Additional sensor data may be optical data and/or electronic data depending on the type of information sensor 140 is configured to collect. Additional sensor data 204 is also transmitted (e.g., optically and/or electrically as appropriate) to analysis module 150.

Additional sensors 140 provide input to processing algorithms. Additional sensors 140 may include, for example, still or video cameras, drones, tilt sensors, seismometers, geophones, temperature sensors, DTS, Distributed Strain Sensors (DSS), Distributed fibre optic sensors (DFOS), satellite imagery, Lidar, weather reports, wind speed, barometers, hydrophones, accelerometers, and/or microphones or the like as would be readily appreciated by the skilled addressee.

System 100 further comprises a plurality of Infrastructure Databases 141 which provide Infrastructure Database data 203 to analysis module 150. Infrastructure Databases 141 may include geographical information systems (GIS) and and/or time-based data feeds. For example, city assets such as street, building, pipe, service access pits, public lighting, city events, water flow rates, traffic flow data, weather information, building usage. Database feeds may provide data in geographical coordinates such that it may be matched to locations on or adjacent to the fibre. It may be temporal feeds such as the current traffic flow and/or the water flow rate at a given time.

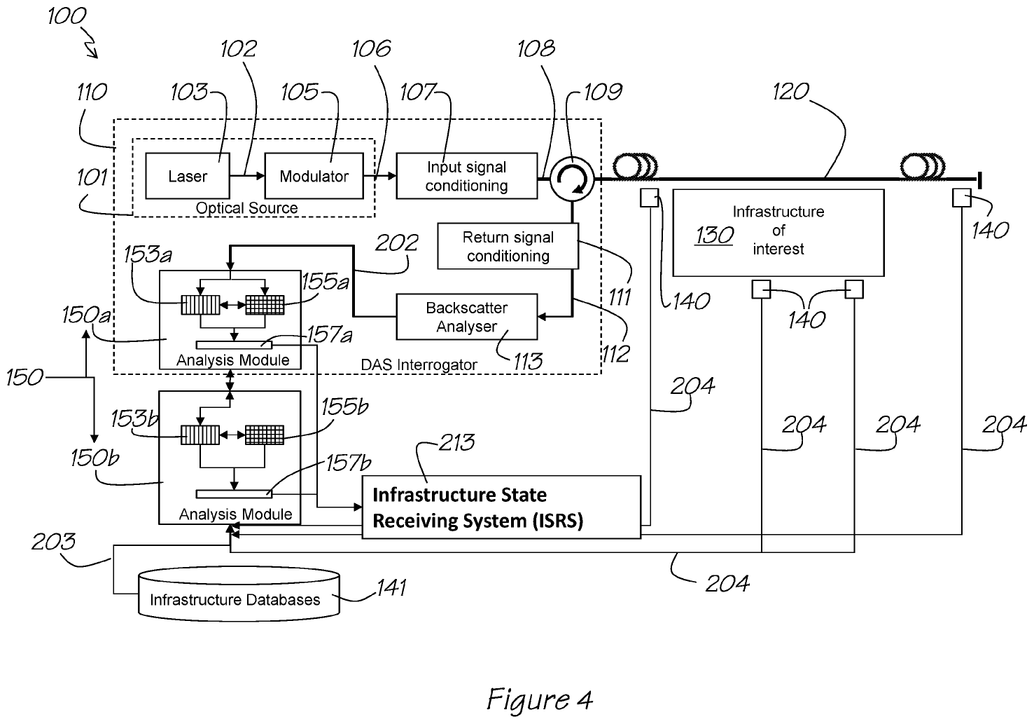

Analysis module 150, also called the Analysis processor 150, comprises at least one memory unit 155 and at least one processor 153 for processing input data according to one or more algorithms stored in memory 155. Processing algorithms generate an output comprising the condition or state of infrastructure 130 which is passed to output module 157. In the particular arrangement as shown in FIG. 1, analysis module 150 is included with DAS interrogator 110, however, in alternate arrangements, analysis module 150 may be separate to the DAS interrogator 110. In the DAS arrangement shown in FIG. 4, the analysis module 150, depicted here as the combination of two modules 150a and 150b, however, in particular arrangements, the analysis module 150 may comprise many separated modules including local connected modules or modules connected by a communications network, for example, as part of a local- or wide-area-network and/or one or more cloud-computing modules connected to local modules, for, example, via the internet. First module 150a may be incorporated into DAS system 100. Further analysis module 150b may be connected directly to analysis module 150a via, for example a wired ethernet cable, or wireless communication protocol (e.g., Wi-Fi, Bluetooth, etc) or the like. Alternatively, second module 150b may be a cloud-computing resource. Each analysis module 150a, and 150b comprises multiple memory units 155a,b and processors 153a,b in different locations acting as a whole to function as the analysis module 150. In an example of this preferred arrangement, the analysis module 150 comprises a combination of local, physical electronic information processing devices found in the DAS interrogator, other sensor systems (such as a DTS or DSS interrogator), local computers, and/or computers in a datacentre as part of cloud-computing infrastructure (also known as cloud-computers).

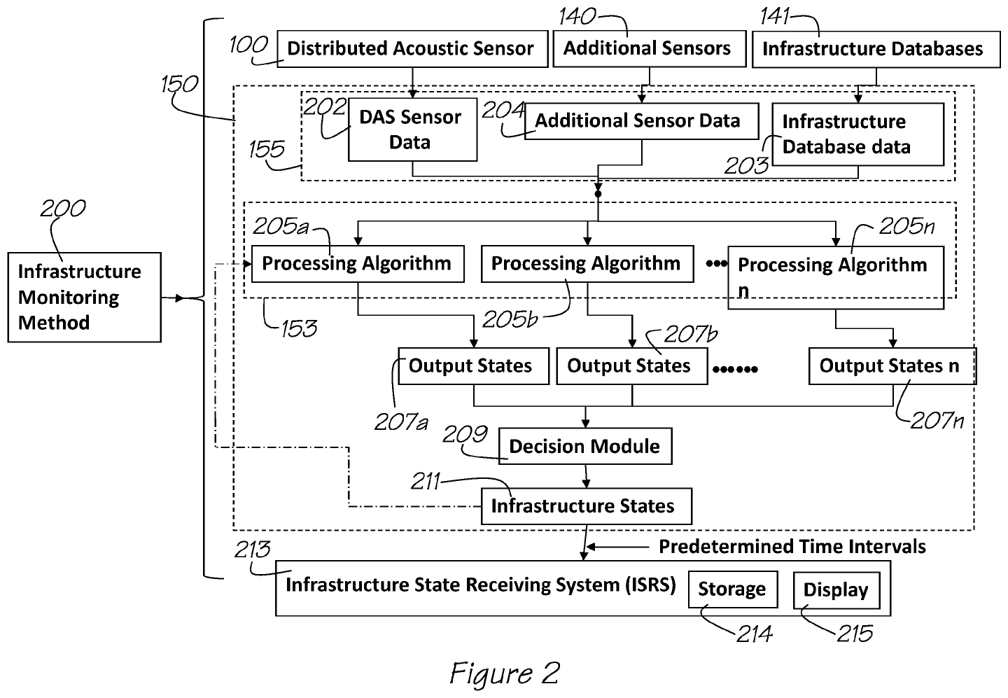

Analysis module 150 receives the DAS data 202 from backscatter analyser 113 and additional sensor data 204 from the plurality of additional sensors 140 and processes the received data in accordance with infrastructure monitoring method 200 as depicted schematically in FIG. 2 and described in detail below into a form suitable for determining the condition or current state of the infrastructure 130. Sensor information 202 from a DAS system may optionally include one or more of acoustics, vibration, strain rate, strain, velocity, deformation, and deformation rate. DAS data 202 received from the backscatter analyser 113 may be filtered on the basis of either frequency (spectral filtering) and/or time (temporal filtering). Spectral filtering of the DAS data may also include band-pass filters, notch filters or the like. The filtering of the DAS data may also include shape filtering, for example kurtosis, envelope, skewness filtering. Temporal filtering of the DAS data may include, for example, short-term and long-term averages, percentile filtering, and/or similar data processing techniques. The additional sensor data 204 received from additional sensors 140 will be the type appropriate for the sensor type. For instance: temperature sensors will return a temperature or rate of temperature change; a proximity sensor will return true or false for an object within the proximity sensors range, present object size and dimensions; a water flow meter will return flow volume and flow rate; and a traffic management system might return vehicle count or traffic control signal state; etc.

A length of the infrastructure 130 to be monitored by DAS system 100 in practice is advantageously represented by predetermined sections of optical fibre 120, where each section is preferably selected to be longer than the resolution of the DAS system 100, and sensing fibre 120 may be divided into a plurality of sections each of about 1 m, 5 m, 10 m, or up to 100 m or longer. For a DAS system installation, the entire length of the sensing fibre 120 will generally be divided into one or more sections, and each section can be used for several different purposes e.g., for monitoring different phenomenon types at different locations of the infrastructure 130 being monitored. Each section may be associated with different processing algorithms 205ᵢ (see below), or different parameters applied to the same processing algorithm 205ᵢ. Particular sections may be included or excluded from Infrastructure States analysis processing. Different sections may also be utilised to monitor different classes of infrastructure, for example, a single DAS system 100 may be arranged to monitor for pipeline leaks in a first section of sensing fibre 120 and also to monitor for seismic activity in the vicinity of a pumping station in a further section of the same sensing fibre 120. The separately monitored sections of sensing fibre 120 may be selected in accordance with physical differences or parts of the monitored infrastructure 130, or they may be virtual or logical sections arbitrarily defined in accordance with the system requirements.

If a single installation of optical fibre has geographical regions that overlap, these may be defined as sections and the data and processing algorithm for the overlapping sections may contribute to a single Output State 207 for the geographical location. The collections of Output States 207 from a Processing algorithm 205 at all geographic locations is referred to as Output States 207 which correspond to different sections of the infrastructure and/or fibre. For instance, the optical fibre 120 may run down both sides of a city road and traffic or leak monitoring should result in a single Infrastructure State 211 of the road where the quality of that State 211 being reported is enhanced by the data coming from multiple sections in the vicinity of a common geographical location.

Each Output State 207 representing a section of the infrastructure or fibre, collectively referred to as the Output States 207ᵢ from processing algorithms 205ᵢ, must be selected from a small and finite set of possible identifiers, state descriptions, condition descriptions or values. The Output States 207ᵢ are preferably binary values or alternatively discrete values from a small, restricted, subset of possible values consistent with the type of sensor data being analysed. The Output States 207ᵢ cannot be continuous variables. Examples include selecting an output state from the sets such as {0,1}, {“on”, “off”}, {“loaded”, “unloaded”}, {“band 1”, “band 2”, “band 3”},{“digging”, “grinding”, “rolling”, “footsteps”}, {“faulty”, “normal”} or {“fire”, “normal”}.

Sections of the sensing medium 140 associated with the monitored infrastructure that represent similar characteristics of the monitoring infrastructure may be combined to provide a better Infrastructure States 211. Sections of the sensing medium 140 may be either physical sections associated with particular features of the infrastructure or may alternatively be virtual or logical sections. For instance, multiple sections of a monitored conveyor that represent suspended mounting of frames will be separated from sections that represent fixed mounting of frames. The identification of a loaded or unloaded Infrastructures States 211 of the conveyor is determined from the combination of the output states 207 and infrastructure states 211 for the different sections of the sensing medium 120.

The infrastructure states 211 associated with each section of the sensing medium 120 are generated by analysis module 150 as a function of one or more output states 207 and provided to Infrastructure State Receiving System (ISRS) 213 for reporting the state of the monitored infrastructure 130. Each physical or logical section of sensing medium 120 typically will be provided with a corresponding infrastructure state 211 which in combination provide an overall infrastructure state 211 indicative of the reported state of monitored infrastructure 130.

The systems and methods described herein provide a monitoring solution for infrastructure. Monitoring is for the purpose of operating the infrastructure to ensure it maintains performing its tasks satisfactorily. Monitoring to ensure continued safe operations. Monitoring will involve identifying wearing, degrading, or failing components or elements, and will allow evaluation of the risks involved with the current operations to allow management for inspection, maintenance and/or repair. By monitoring to a digital solution, a digital-twin can be established that presents an overall representation of the health of the monitored infrastructure 130. This allows remote monitoring and so, remote situational awareness of the infrastructure 130.

FIG. 2 shows a schematic overview of an infrastructure monitoring method 200 using DAS system 100, additional sensors 140 and Infrastructure databases 141 to determine a real-time continuous measure of the condition or state of a monitored infrastructure 130.

The Infrastructure monitoring method described may be applied to many monitoring tasks including, but not limited to: leaks in water pipelines; leaks in gas pipelines; excessive usage of water at a single location; water hydrant usage; man-hole intrusions; fibre and cable pulling; fibre cable tampering; pipeline tampering; power cable tampering; services conduit tampering; construction activities; perimeter intrusion; vehicle motion; traffic monitoring; train and rail monitoring; conveyor monitoring; electric motor monitoring; industrial fan monitoring; embankment motion monitoring; tunnel motion and seismic monitoring; infrastructure seismic response; and seismic ground motion.

DAS system 100 generates DAS data 202 which is passed to analysis processor 150. The plurality of additional sensors 140 also passes additional sensor data 204 to analysis processor 150. Infrastructure databases 141 further provide infrastructure database data 203 to analysis processor 150. A processing algorithm 205 will receive input from a sensor 140 that will be in the form most appropriate for that sensor. For the state of an external device this state may be On/Off, open/closed, high/low, engaged/idle, etc. For more complex sensors this may be a stream of values, for example: flow rate, volume count, pressure, intensity, ranking, temperature, radiation, time periods, velocity, mass, length, area, concentration, angle, force.

DAS data 202, sensor data 204 and infrastructure data 203 are stored in memory 155 of the analysis processor 150 to be available to be called by one or more of a plurality of processing algorithms 205a, 205b, . . . , 205n which are also stored in memory 155 and are able to be executed by at least one or a plurality of processors 153 of analysis processor 150. Each processing algorithm 205a . . . n generates an output state 207 relevant to the state of either infrastructure 130 or of DAS system 100 itself and/or the additional sensors 140. As an example of a temperature sensor 140, an output state 207ᵢ from a processing algorithm 205ᵢ may identify either a state of infrastructure 130—e.g., a temperature sensor 140 may indicate that infrastructure 130 is too hot—and/or the condition of temperature sensor 140 itself e.g., the sensor may be either “active and OK” or “failed”.

Examples of processing algorithms 205ᵢ which may be implemented by analysis processor 150 include:
Kurtosis Algorithm: Processing algorithm may use the DAS sensor data to measure the kurtosis in regular time intervals at each section and place the kurtosis value in at least 2 bands where each band is given an identifier. The identifier of the bands will be the output state 207ᵢ of the associated algorithm process 205ᵢ. For example, output state 207 may be chosen to be “band 1” to identify kurtosis values <=4 and “band 2” to identify kurtosis values >10. The Output States 207 for all sections of sensing medium 120 at a given time may then be the collection {“band 1”, “band 1”, “band 1”, “band 2”, . . . , “band 1”}.
Skewness Algorithm: Processing algorithm may use the DAS sensor data to measure the skewness in regular time intervals at each section and place the skewness value in at least 2 bands where each band is given an identifier. The identifier of the bands will be the Output States 207ᵢ of that algorithm process 205ᵢ. For example, output state 207 may be chosen to be “band 1” to identify skewness values >1, “band 2” to identify skewness values between −1 and 1, and “band 3” to identify skewness values <−1. The Output States 207 for all sections of sensing medium 120 at a given time may then be the collection {“band 1”, “band 3”, “band 2”, “band 2”, . . . , “band 2”}.
Envelope Demodulation Algorithm: Where an acoustic time-series may have complex frequency distributions a processing algorithm may perform Envelope Demodulation Analysis on that temporal DAS sensor data at each location. The Envelope Demodulation Analysis score may be calculated using the method described in A review of rolling element bearing vibration “detection, Diagnosis and Prognosis”, by Ian Howard publicly released report DSTO-RR-0013 by the DSTO Aeronautical and Maritime Research Laboratory October 1994. An alternative reference is: Bearing Fault Diagnosis Method Based on Hilbert Envelope Demodulation Analysis, by Nan Wang and Xia Liu, 2018 IOP Conf. Ser.: Mater. Sci. Eng. 436 012009. The calculation can be made at regular time intervals at each section and placed in at least 2 bands where each band is given an identifier. The identifier of the bands will be the Output States 207ᵢ of corresponding algorithm process 205ᵢ. For example, output state 207 may be chosen to be “band 1” to identify Envelope Demodulation Analysis scores <100, and “band 2” to identify scores >100. The Output States 207 for each section of sensing medium 120 may then be the collection {“band 1”, “band 2”, “band 2”, “band 1”, . . . , “band 1”}. Such a method can be used to monitor multiple bearing frequencies indicative of bearing faults.
Neural Network Algorithm: A processing algorithm may be a neural network that takes as input DAS sensor data, external sensor data and/or a multiple of Output States from other processing algorithms and returns Output States selected from a finite set of possibilities used to train the neural network.
Machine Learning Classifier Algorithm: A processing algorithm may be a machine learning classifier an algorithm that takes as input DAS sensor data, external sensor data or a multiple of Output States from other processing algorithms and returns Output States selected from a finite set of possibilities used to train the machine learning classifier model.
Spatial Correlation Algorithm: A processing algorithm may be a correlation of data at one location and data at another location at the same time. Attributes of the correlation are calculated such as the mean, max, standard deviation, or sum. A threshold is applied to the resulting value to determine Output States that may be the collection {“not spatially correlated”, “moderately spatially correlated”, “highly spatially correlated”}.
Temporal Correlation Algorithm: A processing algorithm may be a correlation of data at one point in time with data at a previous time and at the same location. Attributes of the correlation are calculated such as the mean, max, standard deviation, or sum. A threshold is applied to the resulting value to determine Output States that may be the collection {“not temporally correlated”, “moderately temporally correlated”, “highly temporally correlated”}.
Machinery Identification Algorithm: A processing algorithm applied to the DAS sensor data and external sensor data that calculates the frequency spectrum of the data. Frequency peaks are calculated and compared to known machinery frequencies such as 50 Hz, 60 Hz, 30 Hz and their harmonics. The number of peaks that are close to known machinery frequencies are counted; a threshold is applied to the number of machinery peaks to determine whether the data is from machinery. The Output States may be the collection {“machinery not identified”, “machinery identified”}.
Rainfall Algorithm: A processing algorithm applied to weather feeds containing precipitation data, such as local weather stations, or rainfall sensors, or a weather data portal, that estimates how much rainfall is in a geographic location corresponding to the monitored infrastructure. Thresholds may be applied to the precipitation data, which results in Output States from the collection {“no rain”, “light rain”, “moderate rain”, “heavy rain”}.
Temperature Anomaly Algorithm: A processing algorithm applied to DTS temperature data where a smooth temperature trend is calculated and subtracted from the DTS temperature data. This resulting temperature difference is a proxy for how far above or below the local temperature is from the surrounding temperatures. Thresholds can be applied to the current temperature difference which results in Output States from the collection {“no temperature anomaly”, “slightly negative temperature anomaly”, “slightly positive temperature anomaly”, “moderately negative temperature anomaly”, “moderately positive temperature anomaly”, “highly negative temperature anomaly”, “highly positive temperature anomaly”}.
Flow Rate Anomaly Algorithm: A processing algorithm applied to flow rate sensors which monitors the difference in flow between two or more flow rate sensors. A threshold can be applied to the difference in flow which results in Output States from the collection {“normal flow rate”, “slightly reduced flow rate”, “slightly increased flow rate”, “moderately reduced flow rate”, “moderately increased flow rate”, “highly reduced flow rate”, “highly increased flow rate”}.
Pressure Anomaly Algorithm: A processing algorithm applied to pressure sensors located at two or more pipeline locations which monitors the fluid pressure in the pipeline. A difference in pressure is calculated and subtracted from the calculated pressure difference, which is the expected pressure difference given the topology of the pipeline. A threshold can be applied to the resulting value which results in Output States from the collection {“normal pressure difference”, “slightly reduced pressure difference”, “slightly increased pressure difference”, “moderately reduced pressure difference”, “moderately increased pressure difference”, “highly reduced pressure difference”, “highly increased pressure difference”}.
Communication Status Algorithm: A processing algorithm that uses a communications protocol to regularly transmit and receive packet information between the Analysis Module 150 and the DAS Interrogator 100. The time difference between the present time and the previously received packet is calculated. A threshold is applied to the time difference which results in Output States from the collection {“communication up”, “communication down”}.
Spectral Filtered Power Algorithm: A processing algorithm may include spectral filtering where a range of frequencies of spectral domain may be removed. Processing algorithms may use multiple filtering options to help identify the activity type. Spectral filters that may be used include bandpass filters (allowing only frequencies of a specified range), notch filters (removing frequencies of a specified range), high pass filter (removing frequencies below a specified value), or low pass filter (removing frequencies above a specified value) or the like. Examples include: Bandpass Filtering (e.g., 100 Hz-1000 Hz); Lowpass filtering (e.g., <100 Hz); and High pass filtering (e.g., >100 Hz). A computation can then be performed on the retained frequency band. For example, the total acoustic power in the retained frequency band can then be calculated by integrated square of the filtered data, or the standard deviation of the filtered data in regular time intervals and place the power value in at least 2 bands where each band is given an identifier. The identifier of the bands will be the Output States 207ᵢ of that algorithm process 205ᵢ. For example, output state 207 may be chosen to be “band 1” to identify power values <=4 and “band 2” to identify power values >10. The Output States 207 for all sections of sensing medium 120 at a given time may then be the collection {“band 1”, “band 1”,“band 1”, “band 2”, . . . , “band 1”}. Alternatively, the skew of the filtered data can be calculated in regular intervals and placed into at least two bands. The computations that can be performed on the filtered data can include: RMS, standard deviation, skew, kurtosis, crest factor, shape factor, median, and/or range.
Diurnal Filtering Algorithm: A processing algorithm may apply a filter to remove signal effects that reoccur at the same time of the day or the day of the week. Examples include removing the effects of noisy day-time traffic in a city centre, day or night temperature fluctuations, weekend utility usage, weekday commercial office usage. Diurnal filtering may be applied within other processing algorithms, such as Kurtosis, Skewness and/or Spectral filters.
Fibre Signal Quality Algorithm: A processing algorithm may measure the optical signal to noise measurement at each section of the sensing fibre cable 120 with a threshold comparison indicative of suitable signal quality. The Output States 207 for all sections of sensing medium 120 at a given time may then be the collection {“Signal Normal”, “Signal Normal”, “Signal Normal”, “Signal lost”, “Signal lost”, “Signal lost”}.
Fibre Damage Algorithm: A processing algorithm may measure the optical power at each section of the sensing fibre cable 120 with a threshold comparison indicative of fibre continuity or usable state. The Output States 207 for all sections of sensing medium 120 at a given time may then be the collection {“Fibre Normal”, “Fibre Normal”, “Fibre Normal”, “Fibre damaged”, “Fibre damaged”, “Fibre damaged”}.
STLT Algorithm: A processing algorithm that uses data values spanning two different durations of time that are compared to one another, for example as a ratio. The data values can be raw data, pre-processed data, or summarised data, for example, the outputs of a Spectrum Filtered Power Algorithm. A short-term value ST is calculated from data values spanning a duration of time, which may be seconds, minutes, hours or days, and some calculation is performed on this data, for example, the data is averaged, or a percentile is calculated, or a minimum value is calculated, or a maximum value is calculated, and this value is indicative of the short-term activity. A long-term value LT is calculated from data values spanning a duration of time that is longer than the duration used in the short-term calculation, and which may be minutes, hours, days, or weeks, and some calculation is performed on this data, for example the data is averaged, or a percentile is calculated, or a minimum value is calculated, or a maximum value is calculated, and this value is indicative of the long-term activity. The ST and LT values are compared to get an STLT value, for example by calculating a ratio of the two input values. This ratio may be further corrected and normalised, for example by removing diurnal data trends and/or removing spatial data trends and/or dividing by the standard deviation of the data inputs. A rolling statistic such as a rolling minimum, or rolling quantile, may be applied to the corrected and normalised data to establish traits such as whether an activity is persistent. Thresholds can be applied to the final processed STLT values that is indicative of the activity. The Output States for all sections at a given time may then be the collection {“normal activity”, “leak in progress”}.
Root Mean Squared (RMS) Algorithm: A processing algorithm may use the DAS sensor data to measure the RMS in regular times interval at each section of the sensing fibre cable 120 for a specified time. The RMS value can then be placed in at least two bands where each band is given an identifier. The identifier of the bands will be Output States 207ᵢ of that algorithm process 205ᵢ. For example, output state 207 may be chosen to be “Reduced” to identify RMS values less than 0.5, and output state 207 “Excessive sound” to identify RMS values >2.5. The Output States 207 for all sections of sensing medium 120 at a given time may then be in the collection: {“Reduced Sound”, “Increased Sound”, “Excessive Sound”}. The threshold values used for the comparisons can be unique to each section of fibre. The RMS Processing Algorithm Output State may be fed into other Processing Algorithms. For example, the RMS Output State can be fed into the Machine Learning Classifier Processing Algorithm described above as an input into determining idler sound levels.
Shape Factor Algorithm: A processing algorithm can calculate the maximum of the absolute of the signal divided by the RMS value of the signal to obtain a Shape Factor value. The shape factor can be measured at regular intervals for each section of the fibre and its value placed into at least two bands. The identifier of the bands will be the Output States 207ᵢ of that algorithm process 205ᵢ. For example, output state 207 may be chosen to be “Regular signal” to identify Shape Factor values in the range <1.3, and “Irregular signal” to identify signals >1.3. The Output States 207, for all sections of sensing medium 120 at a given time may then be in the collection: {“Regular signal”, “Irregular signal”}. The output of this processing algorithm may be fed into other processing algorithms. For example, the Processing Algorithm RMS, above, may have a dependence on the Shape Factor Output State. If the Shape Factor Output state is “Regular Signal” the threshold value for the “Reduced Sound” state may be <0.5. However, if the Shape Factor Output State is “Irregular signal”, the threshold value for “Reduced Sound” may be <0.1.
Crest Factor Algorithm: A processing algorithm can calculate the maximum of the absolute value of the signal divided by the RMS value of the signal to produce a crest factor value. The crest factor can be measured in regular intervals at each section of the fibre sensing cable and its value placed in at least two bands. The identifier of the bands will be the Output States 207ᵢ of that algorithm process 205ᵢ. For example, output state 207 may be chosen to be “Sinusoidal signal” to identify crest factor values in the range 1.3-1.5, “Constant signal” to identify values in the range 0.9-1.1, and “Triangular signal” to identify values in the range 1.6-1.8. The Output States 207 for all sections of sensing medium 120 at a given time may then be in the collection: {“Sinusoidal signal”, “Constant Signal”, “Triangular signal”, “Irregular signal”}.
Cross-Correlation Algorithm: A processing algorithm can perform a weighted sum of the 0^{th} delay term derived from the cross-correlation of the signal from a section of the fibre against one or more other sections of the fibre. The output of this sum may be normalised using the standard deviation or RMS of the input signals. At this point the weighted sum may be used directly in other processing algorithms such as the STA/LTA. The weighted sum is then placed into at least two bands. The identifier of the bands will be the Output States 207ᵢ of that algorithm process 205ᵢ. For example, output state 207 may be chosen to be “Highly distributed” to identify values greater than 0.9, “Distributed” to identify values in the range 0.6-0.9, and “Localized” to identify values <0.6. The Output States for all sections of sensing medium 120 at a given time may then be in the collection: {“Highly distributed”, “Distributed”, “Localized”}.
Bayesian Classifier Algorithm: A Bayesian classifier that may use any number of continuous variable input data streams, for example STA; LTA; temperature and other data, which are combined using predefined or pre-trained likelihood models and Bayes theorem into a posterior estimate of the event probability. The posterior probability may be updated with sequential observations in time. The posterior probability in the interval 0 to 1 may be binned into any number of discrete Output States 207, for example {“unlikely”, “probable”, “highly probable”, “certain”}.

The processing algorithms may optionally receive input from the DAS, from alternative sensors 140, and/or from the Infrastructure State 211 in a feedback loop. The processing algorithms receive signals from the DAS system 100 that represent the acoustic energy levels at each point along the optical fibre 120 simultaneously. Combining the output from several identification/classification processing algorithms allows further refinement of the Infrastructure States 211 such that it can be regularly passed to a process for analysis and presentation of the overall longer-term Infrastructure States 211 for presentation to an operator of an infrastructure management team. Also, combining DAS sensor data with other sensor data increases the accuracy of identifying activity sensed by the DAS system 100.

Each of the Output States 207a . . . n is passed to a decision module 209 which analyses Output States 205a . . . n to determine Infrastructure States 211 of infrastructure 130 at each section of the infrastructure corresponding to predefined sections of sensing medium 120. Example Infrastructure States 211 at a particular section may include: “Infrastructure normal”; “Potential fault”; “Monitoring possible fault”; “Ongoing fault confirmed”; “Anomalous activity in progress”; “Sensing cable damaged”; or “Sensor data not being received”; and many other similar state identifiers as would be readily appreciated by the skilled addressee. States 211 at a particular section may also include compound state information for the infrastructure and the components of the DAS system 100 including, for example, “Infrastructure normal, Sensing cable normal”. Infrastructure States 211 are finally output by decision module 209 of analysis processor 150 to an Infrastructure State Receiving System (ISRS) 213. The ISRS 213 provides information on the Infrastructure States 211 of infrastructure 130 and the DAS monitoring system 100 to an infrastructure management team who, on the basis of the reported Infrastructure States 211 are able to identify any potential or confirmed faults or potentially adverse phenomena with respect to monitored infrastructure 130 and act as appropriate. In the most preferred embodiment, the ISRS stores the history of the Infrastructure States 211 at all sections of the infrastructure and at all times in a Storage unit 214 and displays some of the Infrastructure States 211 on a display device 215.

A processing algorithm 205ᵢ may optionally receive an input Infrastructure States 211 as determined previously by the infrastructure monitoring method 200. For instance, a previous decision process by decision module 209 has determined an Infrastructure State 211 that is used to further refine a particular selected processing algorithm 205ᵢ calculation of a current Output States 207ᵢ. For example, a conveyor may be determined to be loaded with ore; this “Loaded” state is then used to refine the calculations for determining a future Output States 207ᵢ and, in turn, an updated Infrastructure States 211. The use of previous Infrastructure States 211 in Processing Algorithms 205ᵢ is called a feedback loop.

Output States 207 from a processing algorithm 205 may be a binary value (on/off, true/false, normal/faulty, operating/at rest, ok, failed) or maybe a discrete range of values e.g., running, loaded, unloaded, not running. Output States may be a gradation of values. For instance, likelihood of a leak at a location could be expressed as a percentage likelihood, e.g., 10%, 50%, 70%, or 100%.

Infrastructure States 211 may be a discrete range of values, for example, healthy, OK, at-risk, inspection required, critical, fault identified, etc; or may be an interpreted range of values, for example, green, amber, red, etc; or may be a set of increasing condition states, for example, “OK”; “slightly noisy bearing”; “noisy bearing”; “damaged bearing”; “critical bearing”; “failed bearing”, etc. Output States 207 may be a set of monitor response stages, for example; “no action required”; “regular maintenance required”; “essential maintenance required”; or “urgent maintenance required”. It may present a time range for attention required; Inspection next 24 hours, inspection next 7 days, inspection next 30 days.

Infrastructure States 211 may be a gradation of values, for example, the percentage chance that cable damage requiring attention has occurred at a particular location along the monitored length of the cable infrastructure 130, e.g., 100%, 70%, 50%, 20%; or the maximum pressure applied to a dam wall due to dam contents or weather conditions; and whether that pressure state leads to an Infrastructure States 211 of “low”, “moderate”, “high”, “severe”, or “critical” risk to the integrity of the dam wall infrastructure.

Decision module 209 is a means to combine all the Output States 207 to determine one or more Infrastructure States 211. The Output States 207 of any processing algorithm 205 alone may not be enough to determine the one or more Infrastructure States 211.

The processing steps of method 200 may be executed either on edge and or cloud computers, where edge computers physically located near to or physically connected to DAS system 100 reduce the data volumes that need to be transmitted to cloud computers.

The decision module 209 may use several combinations of Output States 207 to determine Infrastructure States 211. It may use a persistency check where previous Output States are monitored and only when multiple states change over a predetermined time period will decision module 209 set a particular Infrastructure States 211.

Examples of the operation of the decision module 209 may include one or more of the following checks:
Simultaneity Check: The decision module 209 may apply a simultaneity check wherein the combination of multiple Output States 207 are required to set Infrastructure States 211. The simultaneity check may be a series of logical operators, a machine learning algorithm, or a neural network classifier.
Persistence Check: The persistent Output States 207 from a Processing Algorithm 205 or multiple Processing Algorithms is used as a check for Infrastructure States 211. For instance, an Output State 207 needs to be contiguous for a minimum or fixed time period before the Decision Module 209 sets one or more Infrastructure States 211.
Transience Check: The intermittency of a changed Output State 207 or multiple Output States 207 compared to minimum time periods is used to set Infrastructure States 211. The period is determined and set as appropriate for the Processing Algorithm 205.
DAS Data Quality Check: The quality of the DAS signal may be monitored by the Output States 207 of a Fibre signal quality Algorithm. This will impact how much certainty can be given to specific Output States 207 reported by the analysis module 150, and specifically those Output States 207 that use DAS data as an input. If the signal to noise is sufficient, the decision module 209 will allow specific Infrastructure States 211 to be reported to the ISRS 213.
DAS Data Availability Check: DAS data may be unavailable for all or a section of the fibre 120 for periods. A check on receiving valid data from DAS may be used by the Decision Module 209 to determine Infrastructure States 211.
Map Check: A map check includes geographical checks of static or dynamic data at sections of sensing medium 120. Static data may be a map of the sensitivity of the fibre, location of known infrastructure assets (hydrants, manholes, bridges, tunnels). Dynamic Map Check Data may be from Alternate Sensors 140 or Infrastructure Databases 141 such as public databases of city events, traffic flow, water usage. A check on map-based data may be used by the Decision Module 209 to determine Infrastructure States 211.
Video Check: Video systems running through a processing Algorithm 205 deliver Output States 207 of the objects and activities monitored from a video feed. Such an Output States 207 may, for example indicate a medium sized car passing an intersection, or people adjacent to man-hole cover. A check on the video Output States 205 may be used by the Decision Module 209 to determine Infrastructure States 211. The video Output States may be reviewed by a system operator to determine a relevant output state 207 or the video images may be processed and analysed automatically by the processors 153 of the analysis module 150.
Fibre Cable Check: The Output States 207 of a Fibre damage Algorithm may be checked by the decision module 209. “Fibre damaged” may be a specific state that can be reported in the Infrastructure States 211 that are sent to the ISRS 213.
Infrastructure State Check: The decision module 209 may receive infrastructure state 211 as Output States 207 from a processing algorithm 205 receiving infrastructure database data 203 from monitoring infrastructure state 211 from a public Infrastructure Database 141 feed. For instance, aggregate waterflow through a city pipe network may be monitored and a check on this within the Decision Module 209 may be used to set the Infrastructure States 211.
Bayesian Decision Check: This module receives the Output States 207 from a plurality of processing algorithms 205, and in combination with predefined or pre-trained likelihood tables and/or functions, generates a posterior probability of an event. The posterior probability is updated in time as new information becomes available in accordance with Bayes theorem. The posterior probability in the interval 0 to 1 may be binned into any number of discrete Output States 207. This algorithm may be applied to any of the decision checks discussed above, with the added benefit that it integrates data from many independent processing algorithms, which increases the check accuracy.

As discussed above DAS monitoring system 100 is preferentially configured to provide real-time and continuous infrastructure health data (i.e., DAS data 202 and sensor data 204, for example) to analysis module 150. The one or more Infrastructure States 211 are passed to the Infrastructure State Receiving System (ISRS) 213 at regular intervals where it is analysed to provide a final Infrastructure States report to be displayed for review by the infrastructure management team. The time interval may be every fraction of a second (such as micro-second, milli-second, 0.1 second) or every second, 10 seconds, every minute, every 10 minutes, every hour, every day, or within about 10% of each of the above time periods. Therefore, the analysis module 150 is, in turn, able to provide continuous real-time or near-real-time reporting of Infrastructure States 211 to the infrastructure management team. In practice, each of the processing algorithms 205a . . . n are continually receiving sensor data (including DAS data 202 and/or additional sensor data 204 and/or Infrastructure Database data 203) and executing the appropriate algorithm on a time scale consistent with the received sensor data such that the Infrastructure States 211 can be continually reported to the ISRS 213 at predetermined time intervals appropriate to the received sensor data.

Infrastructure States 211 as output by the Decision Module 209 are passed to the ISRS at predefined intervals to provide a continuous update to infrastructure management teams and system operators. This system for periodically reporting the infrastructure state is significantly different from raising an alert and/or notification when an acoustic event is detected. For example, using the presently described systems and methods:
Operators receive continuous information on the status, condition, or activity near infrastructure.
Continuous monitoring allows many possible trigger states or conditions to be supplied to the operator.
Real-time systems may be delayed such that an alert or notification arrives after the incident is initially identified.
A continuous Infrastructure States 211 reporting output, while still possibly delayed, does not result in the false timing of an “incident”. Rather, it is a delayed stream of state.
Operators are not immediately alerted to a problem in a manner they may not be able to respond to.
The gradual and consistent delivery of Infrastructure States 211 avoid immediate over-reaction to alerted “events”.

The continuous-monitoring nature of Infrastructure States 211 allows refinement of the identified activity as more data is received and better analysis can be performed using one or more feedback loops with the processing algorithms 205ᵢ and decision module 209. The identified activity is continuously updated with the possibility to be reclassified on the basis of new sensor data received. The continuous-monitoring nature of multiple Output States 207 to the Decision Module 209 allows a more thorough and complete identification of an incident.

By monitoring all aspects of the Infrastructure States 211 over time, it is possible to identify cases where no reporting of an incident does not necessarily indicate an incident did not occur. The outage of the optical fibre, fault in communications, a fault in the monitoring system or inappropriate configuration of settings are all continuously provided as Infrastructure States which an operator is better able to interpret as not being able to properly report an actual incident. In a pure incident alert style system, the absence of an alert does not indicate everything is without fault.

The ISRS 213 is the concluding step of monitoring method 200. It receives and stores the Infrastructure States 211 at all sections and all times. It may also reduce the Infrastructure States 211 to a simplified representation that is suitable for display to an operator (via display 215) so they are able to make judgemental calls as to the state of the monitored infrastructure 130. Examples include: display, logging, history tracking, storing, comparing with other information, alarming, notification, dispatch of maintenance or inspection personnel, activation of devices such as cameras or drones, initiation of shutdown procedures, generation of a manual inspection instruction, generation of an instruction to listen to audio data or generation of a repair instruction.

Multiple Infrastructure States 211 for each location on the sensing fibre 120 may be presented to the ISRS 213 at each predetermined time interval.

The results from the ISRS 213 may be directly connected to alternative analysis systems such as an integrated supervisory control and data acquisition (SCADA) system, history archiving systems, process control systems, real-time control systems and notification systems.

### EXAMPLES

### Example 1—Pipeline Monitoring

In a first practical example of an Infrastructure Monitoring Method 200, a DAS monitoring system 100 and additional Sensors 140 may operate as follows in the example of a pipeline monitoring system to identify/classify and report. Infrastructure states 211 are sent to the output processor and display 213 at predetermined time intervals from a finite set of Infrastructure States 211 such as, for example, {“normal”, “DAS sensor data not available”, “fibre damaged”, “communication down”, “hydrant usage”, “moderately likely leak in progress”, “highly likely leak in progress”, “moderately likely construction in progress”, “highly likely construction in progress”, “moderately likely tampering in progress”, “highly likely tampering in progress”}.

With reference to method 200 of FIG. 2, DAS Sensor Data 202 comprises acoustic sensor data from optical fibre 120 installed along or in the vicinity of the pipeline infrastructure 130 to be monitored; Additional Sensors 140 may comprise a distributed temperature sensor (DTS), satellite weather sensors, flow meters, pressure gauges, and video data; Infrastructure Databases 141 may comprise known locations of hydrants.

The analysis module 150 reduces the acoustic energy from the DAS Sensor Data 202 to a small data stream of acoustic energy values. The analysis module 150 executes a plurality of processing algorithms 205ᵢ, as discussed below, however not all of the described processing algorithms 205ᵢ are essential. Analysis module 150 only executes such processing algorithms 205i as necessary for a particular infrastructure monitoring application. Processing algorithms 205i which may be chosen as necessary on an application specific basis include a processing algorithm 205a, which calculates the short-term and long-term averages for the quietest Nth percentile of the reduced acoustic energy values, where N is a predetermined percentile typically between 0.01% and 50%. The short-term (ST) and long-term (LT) values are normalised and corrected for spatial and diurnal trends in the data. A rolling minimum is applied to the corrected values to establish the persistency of the data values. A threshold is applied to these values to determine whether a sound threshold has been exceeded and this determines an Output States 207a from the finite set {“no leak sound”, “leak sound”}.

The analysis module 150 reduces the acoustic energy from the DAS Sensor Data 202 to a small data stream of acoustic energy values. The analysis module 150 further executes a processing algorithm 205b, which calculates the short-term and long-term averages for the quietest Nth percentile of the reduced acoustic energy values, where N is a predetermined percentile typically between 0.01% and 50%. The short-term and long-term values are normalised and corrected for spatial and diurnal trends in the data. A rolling quantile is applied to the data with a value typically between 0.01% and 50% to establish the transiency of the sound. A threshold is applied to these values to determine whether a sound threshold has been exceeded and this determines an Output States 207b from the finite set {“no construction sound”, “construction sound”}.

The analysis module 150 reduces the acoustic energy from the DAS Sensor Data 202 to a small data stream of acoustic energy values. The analysis module 150 further executes a processing algorithm 205c, which calculates the short-term and long-term averages for the quietest Nth percentile of the reduced acoustic energy values, where N is a predetermined percentile typically between 0.01% and 50%. The short-term and long-term values are normalised and corrected for spatial and diurnal trends in the data. A rolling quantile is applied to the data with a value typically between 0.01% and 50% to establish the transiency of the sound. A threshold is applied to these values to determine whether a sound threshold has been exceeded and this determines an Output States 207c from the finite set {“no tampering sound”, “tampering sound”}.

The analysis module 150 further executes a processing algorithm 205d, which calculates the correlation between DAS Sensor Data 202 at a location and DAS Sensor Data 202 at other nearby locations. The correlated data is normalised and a threshold is applied to these values to determine an Output States 207d from the finite set {“not spatially correlated”, “spatially correlated”}.

The analysis module 150 further executes a processing algorithm 205e, which calculates the correlation between live DAS Sensor Data 202 and DAS Sensor Data 202 at a previous time. The correlated data is normalised and a threshold is applied to these values to determine an Output States 207e from the finite set {“not temporally correlated”, “temporally correlated”}.

The analysis module 150 further executes a processing algorithm 205f, which calculates the spectrum of the DAS Sensor Data 202 and counts peaks close to those associated with machinery (30 Hz, 50 Hz/60 Hz). The number of peaks determines an Output States 207f from the finite set {“machinery not identified”, “machinery identified”}.

The analysis module 150 reduces the acoustic energy from the DAS Sensor Data 202 to a small data stream of acoustic energy values. The analysis module 150 further executes a processing algorithm 205g, which calculates the kurtosis of the acoustic energy values. Thresholds are applied to the kurtosis values which determines an Output States 207g from the finite set {“low kurtosis”, “moderate kurtosis”, “high kurtosis”}.

The analysis module 150 further executes a processing algorithm 205h, which compares the spectrum of the live DAS Sensor Data 202 with historical spectrums of the DAS Sensor Data 202 that have been determined to depict a representative spectrum under normal operating conditions. The spectral comparison determines an Output States 207h from the finite set {“spectrum unchanged”, “spectrum changed”}.

The analysis module 150 further executes a processing algorithm 205ᵢ, which creates an audio recording of the DAS Sensor Data 202 that is processed through a neural network classifier that determines an Output States 207ᵢ from the finite set {“normal”, “leak”, “machinery”, “construction”, “footsteps”, “digging”, “rolling”, “drilling”, “saw”, “vehicle”, “tampering”}.

The analysis module 150 further executes a processing algorithm 205j, which creates an audio recording of the DAS Sensor Data 202 that is processed through a machine learning classifier that determines an Output States 207j from the finite set {“normal”, “leak”, “machinery”, “construction”, “footsteps”, “digging”, “rolling”, “drilling”, “saw”, “vehicle”, “tampering”}.

The analysis module 150 further executes a processing algorithm 205k, which takes in Additional Sensor Data 204 that is rainfall information from satellite data feeds 140. A threshold is applied to the rainfall data to determine an Output States 207k from the finite set {“no rain”, “light rain”, “moderate rain”, “heavy rain”}.

The analysis module 150 further executes a processing algorithm 205l, which takes in Additional Sensor Data 204 that is temperature information from a DTS system 140 that measures temperature outside the pipe. The temperature is compared to all locations on the pipe and to historical temperature data to determine an Output States 207l from the finite set {“no temperature anomaly”, “slightly negative temperature anomaly”, “slightly positive temperature anomaly”, “moderately negative temperature anomaly”, “moderately positive temperature anomaly”, “highly negative temperature anomaly”, “highly positive temperature anomaly”}.

The analysis module 150 further executes a processing algorithm 205m, which takes in Additional Sensor Data 204 that is the flow rate from digital flow meters 140 located at discrete locations on the pipe. A comparison is made between the flow rate readings to determine an Output States 207m from the finite set {“normal flow rate”, “slightly reduced flow rate”, “slightly increased flow rate”, “moderately reduced flow rate”, “moderately increased flow rate”, “highly reduced flow rate”, “highly increased flow rate”}.

The analysis module 150 further executes a processing algorithm 205n, which takes in Additional Sensor Data 204 that is the fluid pressure from digital pressure meters 140 located at discrete locations on the pipe. A comparison is made between the fluid pressure readings to determine an Output States 207n from the finite set {“normal pressure difference”, “slightly reduced pressure difference”, “slightly increased pressure difference”, “moderately reduced pressure difference”, “moderately increased pressure difference”, “highly reduced pressure difference”, “highly increased anomalous pressure difference”}.

The analysis module 150 further executes a processing algorithm 205o, which takes in Additional Sensor Data 204 that is a video feed from digital video cameras 140 located at discrete locations on the pipe. The video feed is passed as input to a neural network classifier that determines an Output States 207o from the finite set {“normal activity”, “machinery”, “people”, “vehicles”}.

The analysis module 150 further executes a processing algorithm 205p, which takes in Additional Sensor Data 204 that is a video feed from digital video cameras 140 located at discrete locations on the pipe. The video feed is passed as input to a machine learning classifier that determines an Output States 207p from the finite set {“normal activity”, “machinery”, “people”, “vehicles”}.

The analysis module 150 calculates the signal to noise of the DAS Sensor Data 202. The analysis module 150 further executes a processing algorithm 205q, which compares the current SNR of the DAS Sensor Data 202 with historical signal to noise values that are considered to be indicative of a normal fibre state. Thresholds are applied to the signal to noise difference that determines an Output States 207q from the finite set {“DAS data quality good”, “DAS data quality ok”, “DAS data quality bad”}.

The analysis module 150 calculates the signal to noise of the DAS Sensor Data 202. The analysis module 150 further executes a processing algorithm 205r, which compares the current SNR of the DAS Sensor Data 202. Thresholds are applied to the signal to noise that determines an Output States 207r from the finite set {“fibre available”, “fibre damaged”}.

The analysis module 150 runs a processing algorithm 205s which communicates with the Distributed Acoustic Sensor 100 to determine an Output States 207s from the finite set {“communication up”, “communication down”}.

The analysis module 150 reduces the acoustic energy from the DAS Sensor Data 202 to a small data stream of acoustic energy values. The analysis module 150 further executes a processing algorithm 205t, which calculates the time difference to the previous data feed and determines an Output States 207t from the finite set {“DAS sensor data available”, “DAS sensor data not available”}.

An Infrastructure Database 141 containing hydrant locations is passed to a processing algorithm 205u which maps the hydrant locations to the pipeline and determines and Output States 207u from a finite set {“no hydrant in vicinity”, “hydrant in vicinity”}.

The analysis module 150 further executes a processing algorithm 205v whose input and output is the prior Infrastructure States 211 that is from the finite set comprising, for example, {“normal”, “DAS sensor data not available”, “fibre damaged”, “communication down”, “hydrant usage”, “moderately likely leak in progress”, “highly likely leak in progress”, “moderately likely construction in progress”, “highly likely construction in progress”, “moderately likely tampering in progress”, “highly likely tampering in progress”}.

At every pre-determined time interval, for example, every second, 10 seconds, 30 seconds or each minute, the Output States 207a, 207b, . . . 207v are passed to Decision Module 209 that determines one or more Infrastructure States 211, for example, selected from the finite set {“normal”, “DAS sensor data not available”, “fibre damaged”, “communication down”, “hydrant usage”, “moderately likely leak in progress”, “highly likely leak in progress”, “moderately likely construction in progress”, “highly likely construction in progress”, “moderately likely tampering in progress”, “highly likely tampering in progress”} for all locations along the fibre 120.

For example, the Decision Module 209 receives the following Output States at a single location on the fibre from 207a, 207b, . . . 207v respectively: “leak sound”, “no construction sound”, “no tampering sound”, “spatially correlated”, “temporally correlated”, “machinery not identified”, “moderate kurtosis”, “spectrum changed”, “leak”, “leak”, “no rain”, “slightly negative anomalous temperature anomaly”, “slightly reduced flow rate”, “normal pressure difference”, “normal activity”, “normal activity”, “DAS data quality good”, “fibre available”, “communication up”, “DAS sensor data available”, “no hydrant in vicinity”, “normal”. The Decision Module 209 executes a DAS data availability check and determines the data is available and other checks may proceed. The Decision Module 209 further executes a DAS data quality check and determines the data quality is good and other checks may proceed. The Decision Module 209 further executes a fibre cable check and determines the fibre is good and other checks may proceed. The Decision Module 209 further executes a Simultaneity check on the remaining states and determines the Infrastructure State is “moderately likely leak in progress”. The Decision Module 209 further executes a Persistence check by analysing the previous 15 results of the Simultaneity check. The previous 15 results of the Simultaneity check are all “moderately likely leak in progress”. The final state decided by the Decision Module 209 at this location is “moderately likely leak in progress”. This is combined with all the other states at all other locations to create the Infrastructure States 211.

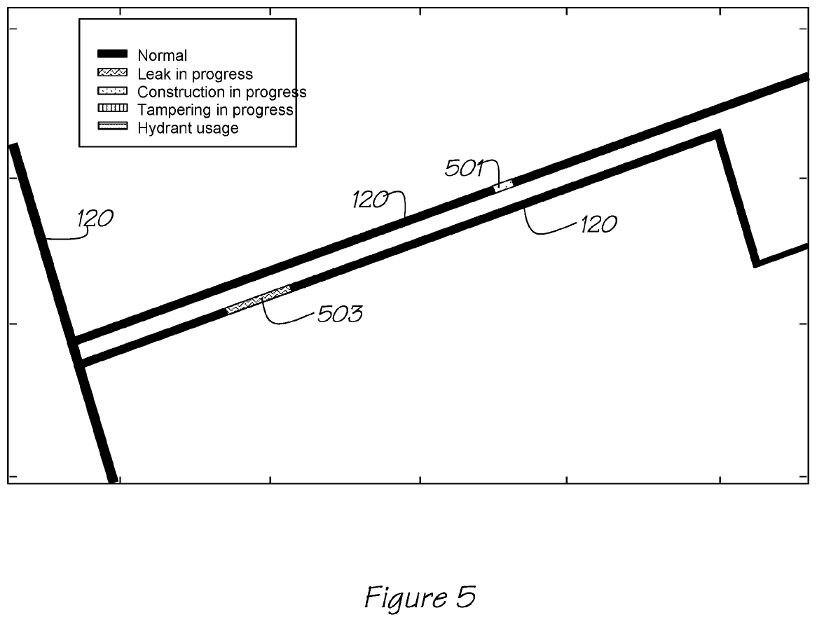

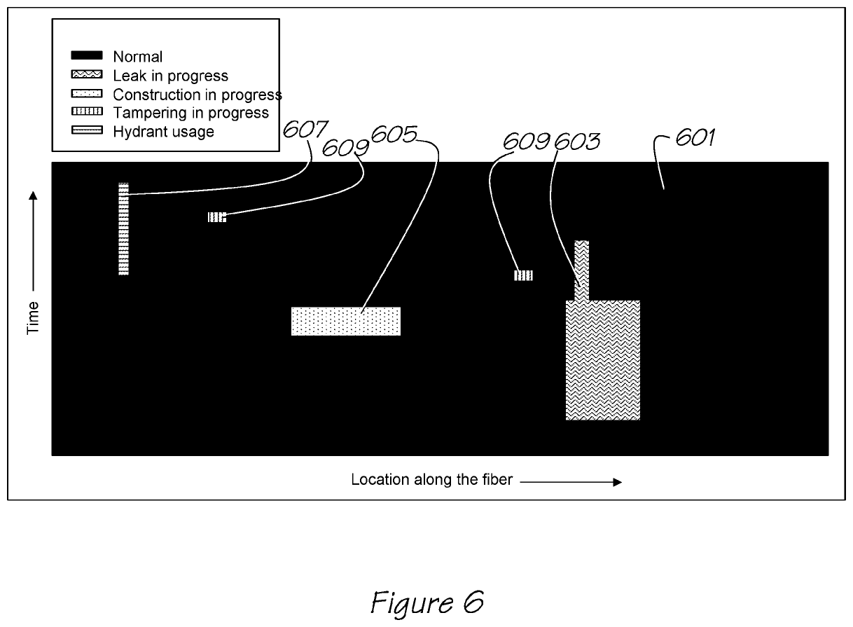

The Infrastructure States 211 are sent to the ISRS 213, e.g., every minute wherein the Infrastructure States 211 is recorded in Storage 214 and displayed on a Display 215. The Display 215 may comprise an output display map of the infrastructure where live and historic Infrastructure States 211 are plotted for end-user attention. The output display map may include additional layer overlays such as topological and/or satellite imagery to assist with determining the location of all Infrastructure States 211. For example, as displayed in FIG. 5, infrastructure states on a map overlay (map details not shown) of sections of a monitored pipeline infrastructure. In the present case depicted in FIG. 5, DAS system 100 includes a plurality of sensing mediums 120 along which various infrastructure state identifiers are displayed including a section 501 of medium 120 which at the time of reporting had detected construction activity in the vicinity of sensing medium 120, and also a section 503 where a leak from the monitored pipeline is detected. FIG. 6 shows an example alternative continuous reporting view of a monitored infrastructure where the horizontal axis represents distance along sensing medium 120 and the vertical axis represents time. Much of the infrastructure state depiction shows an infrastructure state of OK, i.e., no conditions of concern visualised by the solid black colour 601, however conditions of concern to the monitored infrastructure are evident at various locations along the sensing medium and at different times, for example over the reported time, infrastructure states are generated including: a detected leak 603, nearby construction 605, hydrant usage 607, and possible tampering activity 609. From the infrastructure state reporting view shown in FIG. 6 it is readily evident to the infrastructure management team for a monitored infrastructure where an adverse condition exists, how long the condition has been occurring and whether it is still ongoing, and the nature of the adverse infrastructure state so that an appropriate response can be implemented as necessary.

### Example 2—Conveyor Bearing, Roller and Pulley Fault Monitoring

In a second practical example, DAS monitoring system 100 and analysis processor 150 may operate as follows in the example of a monitoring system to identify and report faults in the operation of a conveyor bearing, roller and pulley system.

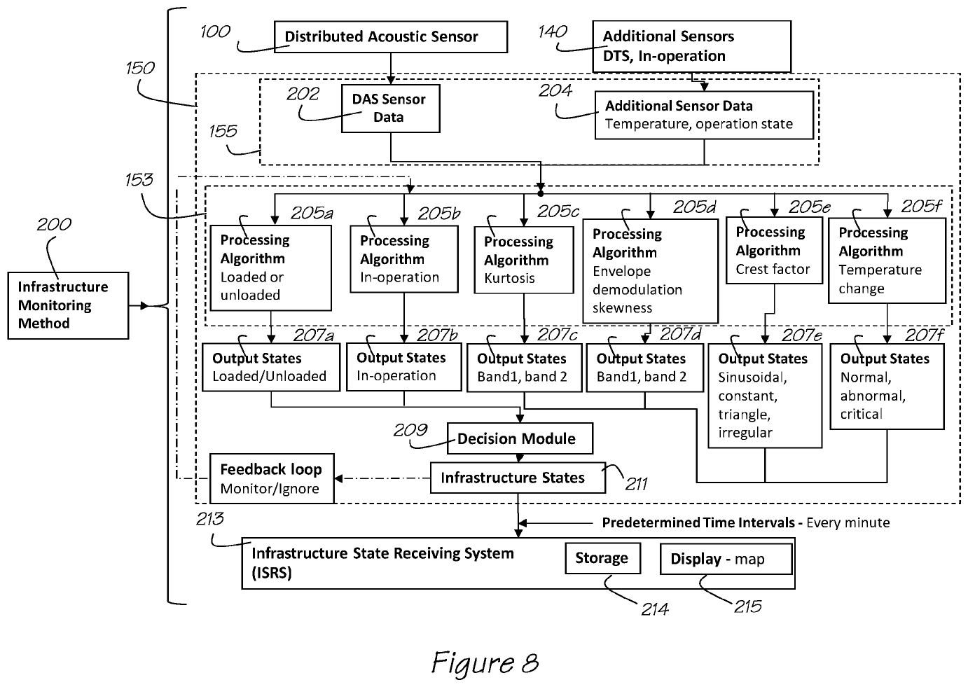

With reference to method 200 of FIG. 2, and as detailed in FIG. 8, DAS data 202 comprises acoustic sensor data from optical fibre 120 installed along and/or in the vicinity of the conveyor infrastructure 130 to be monitored; alternative sensor data may comprise a distributed temperature sensor (DTS) 140, an “in-operation” sensor and a video feed sensor.

Multiple edge processing algorithms 205; convert DAS data 202 to reduced data streams. For example, DAS data 202 is passed to a first processing algorithm 205a to determine acoustic energy levels representative of a load status of a conveyor. First processing algorithm 205a is configured to provide an output state 207a indicating whether the conveyor is either loaded or unloaded.

DAS data 202 is also passed to a second processing algorithm 205b to provide early-warning fault detection of conveyor bearings and provides an output 207b indicating a bearing anomaly state with respect to a location along the conveyor correlated to the distance along the length of fibre 120.

DAS data 202 is also passed to a third processing algorithm 205c to provide early-warning fault detection of idler failure and provides an output 207c indicating an idler failure state with respect to a location along the conveyor correlated to the distance along the conveyor.

DAS data 202 is also passed to a fourth processing algorithm 205d to monitor for idler anomalies and provides an output 207d indicating an idler anomaly state with respect to a location along the conveyor correlated to the distance along the length of fibre 120.

DAS data 202 and sensor data 204 from DTS sensor 140 are also passed to a fifth processing algorithm 205e configured to determine a rate of temperature change with respect to historic temperature change rates and provide an output 207c representative of the temperature along the length of fibre 120 including any temperature anomalies as a function of distance along the monitored conveyor.

Frequency analysis may be used in conjunction with one or more of the processing algorithms to determine the origin of an abnormal activity within monitored infrastructure 130 (not limited to the instant example of a conveyor system) with multiple rotating parts, each rotating at different frequencies. This is the case for bearings on conveyor rollers, motors on fans, pullies, rollers, belts, screw mechanisms, wheels, chain assemblies, internal combustion engines. For example, by analysing the spectral distribution through one of the spectral based filters or routines, a fault on a complex conveyor can be identified to a bearing inner case, a ball bearing, a bearing outer case, a roller shell or an adjacent pulley.

One processing algorithm 205a takes a data stream to determine acoustic energy levels representative of the load status of a conveyor. It sets a conveyor Output States 207a of loaded/unloaded at each conveyor section. Another processing algorithm 205b receives external “in-operation” sensor data 204 to set a conveyor Output States 207b of on/off.

A decision module 209 combines these Output States 207a and 207b to set a Monitor/Ignore Infrastructure States 211 at each section that is returned to further processing algorithms 205c . . . n to monitor idler and pulley status. This is an instance of a feedback loop to the processing algorithms 205ᵢ.

A further processing algorithm 205c calculates the frequency distribution of the sounds and applies a kurtosis routine to determine the shape of the acoustic sound signature against bearing and roller failures. This returns an Output States 207c of each bearing section of the conveyor to band1, band 2.

A further processing algorithm 205d uses skew and envelope demodulation analysis of the frequency distribution. Envelope demodulation and skew is performed at fundamental known frequencies of the bearing inner and outer case sizes and ball bearing size to provide further details on the type of bearing anomaly identified. The processing algorithm returns an Output States 207d at each bearing section of the conveyor; band 1, band 2.

A further processing algorithm 205e uses the Crest Factor analysis to determine the shape of the signal at each section of the conveyor. The return from this processing algorithm is an Output States 207e in a range; sinusoidal signal, constant signal, triangle signal, irregular signal.

DAS data 202 and sensor data 204 from DTS sensor 140 are also passed to a further processing algorithm 205f configured to determine a rate of temperature change with respect to historic temperature change rates and provide an output 207f representative of the temperature along the length of fibre 120 including any temperature anomalies as a function of distance along the monitored conveyor. Output States in the range; normal, abnormal, critical

The decision module 209 takes the above-described multiple Output States 207 to calculate an Infrastructure States 211. The Decision Module applies Simultaneity Checks across multiple algorithm's Output States. It further applies Persistence Checks for kurtosis, skew and envelope demodulation to determine overall conveyor state for each location along the fibre 120. This state 211 is passed to the ISRS 213 every minute regardless of the value of Infrastructure States 211. The ISRS 213 displays conveyor section status for the overall conveyor. In this example ISRS 213 may comprise a map of the health of the conveyor bearings and idlers at each location along fibre 120 including an indication of possible bearing and idler anomalies or failures. The ISRS 213 may also include charts of the ongoing and/or overall monitoring data from system 100.

### Example 3—Data Cable Infrastructure States Monitoring

In a third practical example, DAS monitoring system 100 and analysis processor 150 may operate as follows in the example of a monitoring system to monitor the state of data cable installed in an urban environment.

With reference to method 200 of FIG. 2, DAS data 202 comprises acoustic sensor data from optical fibre 120 installed with and/or in the vicinity of the data cable infrastructure 130 to be monitored; alternative sensor data may be one or a plurality of video cameras 140 providing a video feed(s) of manhole access points. Infrastructure Databases 141 provide Infrastructure Database data 203 as a public database of man-hole locations and database feed of authorised man-hole access schedules.

DAS data 202 is passed to a first processing algorithm 205a to determine acoustic energy levels representative of construction activity in the vicinity of the data cable. First processing algorithm 205a is configured to provide Output States 207a indicating whether any construction activity is present or not at each section of sensing medium 120. Output States are in the range; construction present, no construction activity.

DAS data 202 is also passed to a second processing algorithm 205b to provide monitoring for cable tampering and provides an output 207b indicating a cable handling state with respect to a location along the cable correlated to the distance along the length of fibre 120. The processing algorithm 205 uses a combination of envelope modulation and skewness algorithm to provide Output State 207b for each location on the fibre 120 in range of; normal fibre, direct tampering, mild tampering, unknown activity.

DAS data 202 and sensor data 204 from video camera 140 are also passed to a third processing algorithm 205c configured to determine whether the monitored manhole access points have been accessed and provide an output 207c representative of any manhole accesses. Output States 207 are in the range; man-hole access, no access.

DAS data 202 and Infrastructure Database data 141 from a public database and a database of authorised man-hole access schedules are passed to a processing algorithm 205d and used to determine an Output States of man-hole locations in respect to the monitored fibre 120 and the expected activity at each man-hole location. The range of Output States 207d for each location of the fibre are; no manhole, manhole with no access, authorised access, unauthorised access.

Decision module 209 receives Output States 207a, 207b, 207c and 207d to apply a Simultaneity check to determine whether the cable handling states correlate with any construction activity of any manhole accesses. It applies a Transient check to determine if the period represents a possible tampering. This decision processing is repeated for each location of fibre 120.

Infrastructure states 211 comprises a cable infrastructure activity state at each location along fibre 120 which is reported to the ISRS 213 every 10 minutes, regardless of the value of Infrastructure States 211. In this example, the ISRS 213 may comprise a map of the cable activity at each location along fibre 120 including an indication of possible damage and/or tampering incidences. The ISRS 213 may also include charts of cable activity sensed over time from system 100.

### Implementation Example—Hardware Overview

According to one embodiment, the processing algorithms 205 and the analysis procedures disclosed with reference to analysis module 150, decision module 209 and the ISRS 213 of method 200 described herein are implemented by at least one computing device 300. The techniques may be implemented in whole or in part using a combination of at least one server computer and/or other computing devices that are coupled using a network, such as a packet data network. The computing devices may be hard-wired to perform the techniques, and/or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

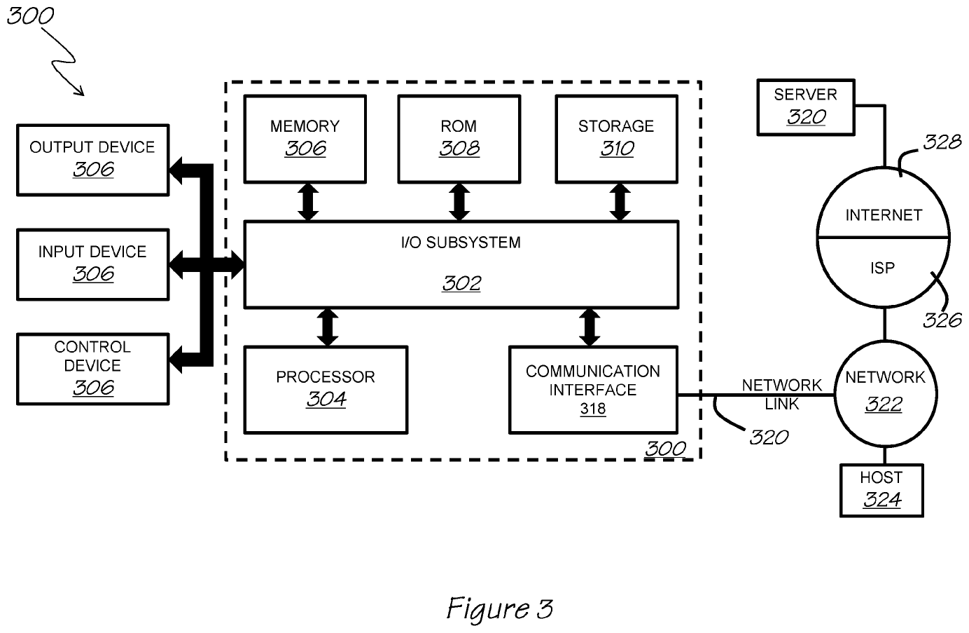

FIG. 3 is a block diagram that illustrates an example computer system with which embodiments of the present invention may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanism(s) for communicating information and/or instructions between the components of the computer system 300 over electronic signal paths. The I/O subsystem 302 may include an I/O controller, a memory controller and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or other dynamic storage device. Memory 306 also may be used for storing temporary variables or other intermediate information during execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read only memory (ROM) 308 or other static storage device coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disk such as CD-ROM or DVD-ROM, and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include other type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators, or servos.

At least one input device 314 is coupled to I/O subsystem 302 for communicating signals, data, command selections or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic sensors, other sensors or sensors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fibre optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fibre optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 such as place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to network link(s) 320 that are directly or indirectly connected to at least one communication networks, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example an Ethernet cable or a metal cable of any kind or a fibre-optic line or a telephone line. Network 322 broadly represents a local area network (LAN), wide-area network (WAN), campus network, internet, or any combination thereof. Communication interface 318 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic, or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through a network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a world-wide packet data communication network represented as internet 328. A server computer 330 may be coupled to internet 328. Server 330 broadly represents any computer, data center, virtual machine or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer and data storage layer such as a relational database system using structured query language (SQL) or no SQL, an object store, a graph database, a flat file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DBaaS provider manages or controls the underlying cloud infrastructure, applications, and servers, including one or more database servers.

### EMBODIMENTS

Reference throughout this specification to “one embodiment”, “an embodiment”, “one arrangement” or “an arrangement” means that a particular feature, structure or characteristic described in connection with the embodiment/arrangement is included in at least one embodiment/arrangement of the present invention. Thus, appearances of the phrases “in one embodiment/arrangement” or “in an embodiment/arrangement” in various places throughout this specification are not necessarily all referring to the same embodiment/arrangement, but may. Furthermore, the particular features, structures or characteristics may be combined in any suitable manner, as would be apparent to one of ordinary skill in the art from this disclosure, in one or more embodiments/arrangements.

Similarly, it should be appreciated that in the above description of example embodiments/arrangements of the invention, various features of the invention are sometimes grouped together in a single embodiment/arrangement, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment/arrangement. Thus, the claims following the Detailed Description are hereby expressly incorporated into this Detailed Description, with each claim standing on its own as a separate embodiment/arrangement of this invention.

Furthermore, while some embodiments/arrangements described herein include some, but not other, features included in other embodiments/arrangements, combinations of features of different embodiments/arrangements are meant to be within the scope of the invention, and form different embodiments/arrangements, as would be understood by those in the art. For example, in the following claims, any of the claimed embodiments/arrangements can be used in any combination.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Such variations are not to be regarded as a departure from the disclosure, and all such modifications are intended to be included within the scope of the disclosure.

The method steps, processes, and operations described herein are not to be construed as necessarily requiring their performance in the particular order discussed or illustrated, unless specifically identified as an order of performance. It is also to be understood that additional or alternative steps may be employed.

Reference to positional descriptions and spatially relative terms), such as “inner”, “outer”, “beneath”, “below”, “lower”, “above”, “upper” and the like, are to be taken in context of the embodiments depicted in the figures and are not to be taken as limiting the invention to the literal interpretation of the term but rather as would be understood by the skilled addressee.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected, or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises”, “comprising”, “including”, and “having”, or variations thereof are inclusive and therefore specify the presence of stated features, integers, steps, operations, elements, and/or components, but do not preclude the presence or addition of one or more other features, integers, steps, operations, elements, components, and/or groups thereof.

### SPECIFIC DETAILS

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### DIFFERENT INSTANCES OF OBJECTS

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

### COMPRISING AND INCLUDING

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: “including” or “which includes” or “that includes” as used herein is also an open term that also means “including at least” the elements/features that follow the term, but not excluding others. Thus, including is synonymous with and means comprising.

### SCOPE OF INVENTION

Thus, while there has been described what are believed to be the preferred arrangements of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the mobile device industries, specifically for methods and systems for distributing digital media via mobile devices.

It will be appreciated that the systems and methods described/illustrated above at least substantially provide an improved infrastructure monitoring system.

The infrastructure monitoring systems and methods described herein, and/or shown in the drawings, are presented by way of example only and are not limiting as to the scope of the invention. Unless otherwise specifically stated, individual aspects and components of the infrastructure monitoring systems and methods may be modified, or may have been substituted therefore known equivalents, or as yet unknown substitutes such as may be developed in the future or such as may be found to be acceptable substitutes in the future. The infrastructure monitoring systems and methods may also be modified for a variety of applications while remaining within the scope and spirit of the claimed invention, since the range of potential applications is great, and since it is intended that the present infrastructure monitoring systems and methods be adaptable to many such variations.

1. A method for monitoring an infrastructure of interest, the method comprising:
providing a distributed acoustic sensor, an analysis module, optical fibre adjacent to the infrastructure, and an infrastructure state receiving system (ISRS),
wherein the optical fibre comprises one or more logical sections, and the distributed acoustic sensor generates DAS sensor data from the one or more sections; and
wherein the analysis module comprises at least one processor and at least one memory unit, wherein the memory unit comprises at least two or more processing algorithms, wherein the one or more processors are configured to execute the processing algorithms with the DAS sensor data as input;
wherein each of the at least two or more processing algoritms are configured to provide a time-varying output state for each logical section of the optical fibre;
generating, by a decision module, one or more time-varying infrastructure states corresponding to a respective logical section of optical fibre using the output states of at least two processing algorithms; and
transmitting the one or more infrastructure states to the ISRS at approximately predetermined time intervals.

2-16. (canceled)

17. The method of claim 1, wherein the analysis module comprises a plurality of separated analysis modules, each analysis module comprising one or more processors and one or more memory units, the plurality of separated analysis modules acting as a whole.

18. The method of claim 17, wherein the analysis module comprises a combination of local, physical electronic information processing devices found either in the distributed acoustic sensor, other sensor systems, local computers, and/or computers in a datacentre as part of cloud computing infrastructure.

19. The method of claim 1, wherein the infrastructure of interest is either a pipeline, a cable, a conveyor, an embankment or tailings storage facility, an underground tunnel or mine tunnel, an open pit mine, a well or a borehole.

20. The method of claim 1, where a processing algorithm receives as an input a prior infrastructure state from the same or different logical sections of the optical fibre.

21. The method of claim 1, where additional sensors are used and the analysis module receives additional sensor data from the additional sensors as input to the one or more processing algorithms, the additional sensors including one or more of: cameras, traffic summaries, vehicle location, public event data feeds, water flow counters, weather data feeds, geo-location of known landmarks such as hydrants, road intersections, utility pits and terrain variations, distributed temperature sensing, distributed fibre optic sensing, accelerometers, seismometers, geophones and hydrophones.

22. The method of claim 1, wherein the at least two or more processing algorithms are selected from one or more of the group comprising:
a skewness algorithm, an envelope demodulation algorithm, a neural network algorithm, a machine learning classifier algorithm, a spatial correlation algorithm, a temporal correlation algorithm, a machinery identification algorithm, a rainfall algorithm, a temperature anomaly algorithm, a flow rate anomaly algorithm, a pressure anomaly algorithm, a communication status algorithm, a spectral filtered power algorithm, a diurnal filtering algorithm, a fibre signal quality algorithm, a fibre damage algorithm, a bayesian classifier algorithm, an STLT algorithm, a root mean squared (RMS) algorithm, a shape factor algorithm, a crest factor algorithm, cross correlation algorithm, a fibre signal quality algorithm or fibre damage algorithm.

23. The method of claim 1, wherein the decision module generates the infrastructure state for each respective logical section using one or more of: a simultaneity check; a persistence check; a transience check; a DAS data quality check; a DAS data availability check; a map check; a video check; a fibre cable check; a bayesian decision check, or an infrastructure state check.

24. The method of claim 1, further comprising determining an inspection or maintenance response of the infrastructure.
